(19) United States
(12) Patent Application Publication
(10) Pub. No.: US 2009/0215642 A1
(43) Pub. Date: Aug. 27, 2009

(54) Methods and Compositions for Assessing Alterations in Gene Expression Patterns in Clinically Normal Tissues Obtained from Heterozygous Carriers of Mutant Genes Associated with Cancer and Methods of Use Thereof

(76) Inventors: Alfred G. Knudson, Philadelphia, PA (US); Alfonso Bellacosa, Philadelphia, PA (US); Margie L. Clapper, Harleysville, PA (US); James A. Crowell, Myersville, MD (US); Levy Kopelovich, Annandale, VA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/096,685

(22) PCT Filed: Dec. 11, 2006
(86) PCT No.: PCT/US2006/047222

§ 371 Date: Oct. 9, 2008

Related U.S. Application Data
(60) Provisional application No. 60/749,234, filed on Dec. 9, 2005.
(60) Provisional application No. 60/840,842, filed on Aug. 29, 2006.

(51) Int. Cl. C40B 30/04; C40B 40/06

(52) U.S. Cl. 506/9; 506/16

(57) ABSTRACT

Compositions, kits, and methods are provided for assessing alterations in gene expression in heterozygous carriers of mutant genes associated with cancer.

This application claims priority under 35 U.S.C. §119(e) to U.S. Provisional Patent Application No. 60/749,234, filed on Dec. 9, 2005 and U.S. Provisional Patent Application No. 60/840,842, filed on Aug. 29, 2006. The foregoing applications are incorporated by reference herein.

Pursuant to 35 U.S.C. §202(c), it is acknowledged that the U.S. Government has certain rights in the invention described herein, which was made in part with funds from the National Cancer Institute, Grant Number CA-06927.

### FIELD OF THE INVENTION

This invention relates to the fields of oncology and molecular biology. More specifically, the present invention provides methods and compositions for identifying and characterizing altered gene expression in heterozygous carriers of mutant genes associated with cancer.

### BACKGROUND OF THE INVENTION

Several publications and patent documents are cited throughout the specification in order to describe the state of the art to which this invention pertains. Each of these citations is incorporated herein by reference as though set forth in full.

The adage that an ounce of prevention is worth a pound of cure may be nowhere more applicable than to cancer. Even a brief consideration of three of the world's most important cancers, e.g., carcinomas of the lung, liver, and cervix, strongly favors that adage. Now, as the pool of cancers that have a clearly environmental causation shrinks, scientists have turned to other major carcinomas—those of colon, breast, and prostate—for the possibility of prevention. Four categories of causation, or oncodemes, are generally recognized: 1) environmental, 2) genetic, 3) interactive between environmental and genetic, and 4) background or spontaneous, a category that reflects the fact that somatic mutations play an important role in oncogenesis and that they occur at endogenous rates in all dividing cells. Categories (2) and (4) assume a conspicuous position, especially for colon cancer, where some of the same genetic alterations occur in both heritable and sporadic forms.

Spontaneous tumors (category 4) represent a large, difficult to quantify fraction of all cancer and will not be eliminated by removal of offending agents. Present efforts to reduce it are directed at early diagnosis and treatment. Some such cancers, including carcinoma of the colon, typically arise from recognizable precursor legions that become malignant at a low rate and after a considerable passage of time. Furthermore, there exists a genetic predisposition to the formation of these precursors in very large numbers. When this genetic predisposition is, for example, a mutation in a gene, it would be desirable to prevent the occurrence of a second event that results in mutation or loss of the second allele, i.e., secondary prevention.

Recent progress in elucidating specific molecular events associated with carcinogenesis has intensified efforts to discover biomarkers and agents that target critical pathways with the potential to be effective in the treatment or prevention of cancer. Prevention may be considered as either primary (i.e., preventing the earliest events in route to cancer) or secondary (i.e., preventing or greatly delaying tumor progression).

Tuberous sclerosis complex (TSC) is a tumor suppressor gene syndrome characterized by seizures, mental retardation, autism, and tumors of the brain, retina, kidney, heart, and skin (Gomez et al. (1999) Tuberous Sclerosis Complex, 3rd ed., New York: Oxford University Press). Renal disease in TSC includes epithelial cysts, angiomyolipomas (benign tumors with vascular, smooth muscle, and lipomatous components), and renal cell carcinoma (RCC). RCC in TSC is morphologically heterogeneous, including clear cell, papillary, and chromophobe types (Al-Saleem et al. (1998) Cancer; 83:2208-16; Bjornsson et al. (1996) Am. J. Pathol., 149:1201-8). The average age of onset of RCC in TSC is 33 years, in contrast to an average age of 55 years in the general population (Al-Saleem et al. (1998) Cancer, 83:2208-16; Bjornsson et al. (1996) Am. J. Pathol., 149:1201-8; Pea et al. (1998) Am. J. Surg. Pathol., 22:180-7). TSC has been attributed to mutations in two genes: TSC1, on chromosome 9q34, and TSC2, on chromosome 16 p13 (van Slegtenhorst et al. (1997) Science, 277:805-8; European Chromosome 16 Tuberous Sclerosis Consortium (1993) Cell, 75:1305-15). Tuberin, the TSC2 gene product, and hamartin, the TSC1 gene product, physically interact and appear to function in multiple cellular pathways, including inhibition of mTOR and S6 Kinase through the small GTPase Rheb, vesicular trafficking, regulation of the G₁ phase of the cell cycle, steroid hormone regulation, and Rho activation (Plank et al. (1998) Cancer Res, 58:4766-70; van Slegtenhorst et al. (1998) Hum. Mol. Genet., 7:1053-7; Kwiatkowski et al. (2002) Hum. Mol. Genet., 11:525-34; Goncharova et al. (2002) J. Biol. Chem., 277:30958-67; Kenerson et al. (2002) Cancer Res., 62:5645-50; Karbowniczek et al. (2003) Am. J. Pathol., 162:491-500; El-Hashemite et al. (2003) Lancet, 361:1348-9; Inoki et al. (2002) Nat. Cell. Biol., 4:648-57; Gao et al. (2002) Nat. Cell. Biol., 4:699-704; Jaeschke et al. (2002) J. Cell Biol., 159:217-24; Zhang et al. (2003) Nat. Cell Biol., 5:578-81; Saucedo et al. (2003) Nat. Cell Biol., 5:566-71; Stocker et al. (2003) Nat. Cell Biol., 5:559-66; Li et al. (2004) Trends Biochem. Sci., 29:32-8; Xiao et al. (1997) J. Biol. Chem., 272:6097-100; Ito et al. (1999) Cell, 96:529-39; Soucek et al. (1997) J. Biol. Chem., 272:29301-8; Miloloza et al. (2000) Hum. Mol. Genet., 9:1721-7; Potter et al. Cell, 105:357-68; Tapon et al. (2001) Cell, 105:345-55; Henry et al. (1998) J. Biol. Chem., 273:20535-9; Lamb et al. (2000) Nat. Cell Biol., 2:281-7; Astrinidis et al. (2002) Oncogene, 21:8470-6).

Von Hippel-Lindau (VHL) disease predisposes a person to cerebellar and spinal hemangioblastoma, retinal angioma, pancreatic cysts, pheochromocytoma, and clear cell renal carcinoma (Linehan et al. (2001) The Metabolic and Molecular Basis of Inherited Disease, New York: McGraw-Hill, 907-29; Linehan et al. (2002) The Genetic Basis of Human Cancer, New York: McGraw-Hill; Linehan et al. (2003) J. Urol., 170:2163-72). The kidney tumors are bilateral, multifocal (often 500 or more tumors per kidney) and can occur at an early age (Poston et al. (1995) J. Urol., 153:22-6; Walther et al. (1995) J. Urol., 154:2010-4). The VHL tumor suppressor gene is mutated in the germline of virtually all VHL kindreds, and somatically in most sporadic clear cell renal carcinomas (Latif et al. (1993) Science, 260:1317-20; Stolle et al. (1998) Hum. Mutat., 12:417-23; Gnarra et al. (1994) Nat. Genet., 7:85-90; Shuin et al. (1994) Cancer Res., 54:2852-5). Reintroduction of the VHL cDNA to VHL^{-/-} cells results in loss or reduction of tumor formation in xenograt′ models (Gnarra et al. (1996) Proc. Natl. Acad. Sci., 93:10589-94; Lubensky et al. (1996) Am. J. Pathol., 149:2089-94). The VHL gene product belongs to a complex with ubiquitin ligase activity that targets proteins for proteosome-mediated degradation (Linehan et al. (2003) J. Urol., 170:2163-72; Kim et al. (2003) Curr. Opin. Genet. Dev., 13:55-60). Under normoxic conditions, VHL targets the transcription factor HIF1 (hypoxia-inducible factor 1) for degradation. In hypoxic conditions, degradation does not take place and HIF1 accumulates, leading to increased transcription of the mRNAs for VEGF, PDGF, TGFα and erythropoietin. Loss of VHL factor allows HIF1 accumulation in the absence of hypoxia, and increased transcription of these growth factor genes can promote tumorigenesis (Linehan et al. (2003) J. Urol., 170:2163-72; Kim et al. (2003) Curr. Opin. Genet. Dev., 13:55-60).

Previous reports failed to determine whether any of the molecular changes associated with mutation of both copies of the TSC or VHL gene in tumor cells also occur in normal-appearing cells that harbor a mutation in just one copy (i.e., single-hit cells) (Knudson, A. G. (2001) Nat. Rev. Cancer, 1:157-62).

### SUMMARY OF THE INVENTION

While certain cancers are exemplified herein, the methods of the instant invention can be extrapolated to any type of cancer. Furthermore, while disorders associated with heterozygous carriers of mutant tumor suppressor genes (e.g., TSC and VHL) are described herein, the methods of the instant invention can be extrapolated to heterozygous carriers of any mutant gene associated with predisposition to cancer.

In accordance with the present invention, it has been discovered that phenotypically normal cells from patients who are heterozygous carriers of a mutant gene associated with cancer exhibit altered gene expression when compared to cells which do not contain the mutation. In a particular embodiment, microarrays of these differentially expressed nucleic acid molecules are provided.

In accordance with another aspect of the invention, methods for identifying genes which are differentially expressed in heterozygous carriers of a mutant gene associated with cancer (e.g., mutant tumor suppressor gene, DNA repair gene, oncogene) are provided. The methods comprise obtaining a biological sample from a heterozygous carrier of a mutant gene associated with cancer, generating detectably labeled probes from the nucleic acid molecules of the biological sample, hybridizing the labeled probes with a microarray (e.g., a cDNA microarray), and comparing the hybridization profile of the heterozygous carrier with the hybridization profile from a biological sample from a normal individual. The population of differentially expressed mRNAs represents a “genetic signature” of the heterozygous carriers of a mutant gene associated with cancer. Members of the genetic signature of the cancer are targets for the development of cancer detection strategies (particularly early stages of cancer), chemotherapeutic agents, and chemopreventive agents. Significantly, the differentially expressed nucleic acid molecules may be used as the target for the detection of not only the mutant gene associated with cancer of the heterozygous carrier, but to all cancers including, for example, other hereditary cancers, familial cancers, and sporadic cancers.

In a further embodiment of the invention, methods are provided for identifying agents which modulate the biological activity of the differentially expressed molecules identified by the methods described above. An exemplary method entails generating engineered cells expressing one or more of the differentially expressed nucleic acids and exposing them to a test agent. The cells are then assessed for phenotypic, metabolic and/or morphological alterations in the treated cells when compared to untreated control cells. Agents which modulate cell growth and proliferation can be identified using such methods which may have efficacy as chemopreventive agents and chemotherapeutic agents. Significantly, the efficacious agents may be used against not only the cancer related to the mutant gene associated with cancer of the heterozygous carrier, but to all cancers including, for example, other hereditary cancers, familial cancers, and sporadic cancers.

### BRIEF DESCRIPTION OF THE DRAWINGS

FIGS. 1A-1C are images of primary cultures of normal renal epithelial cells from individuals affected with the dominantly heritable syndromes tuberous sclerosis complex (FIG. 1A) and von Hippel-Lindau syndrome (FIG. 1B) and from control patients (FIG. 1C).

FIG. 2A is a table which provides the expression levels of five genes, relative to ACTB, as determined by real-time RT-PCR. Average slopes for the three samples (control, TSC, and VHL) are indicated. FIG. 2B is a graphical representation of the correlation between gene expression ratios assessed by microarray analysis and real-time RT-PCR. Data are presented on a log₂ scale.

FIG. 3 is a graphical representation of 10 genome-wide arrays in a plane defined by the first two Principal Components. Each point represents an individual array. Four TSC arrays (two replicates and two dye-flips) are indicated (the asterisk indicates two points that are strongly overlapping). Six VHL arrays (four replicates and two dye-flips) are also indicated. The experimental error is smaller than the variation that exists between the two syndromes.

FIG. 4 is a representation of the cluster analysis of ribosomal protein gene expression in TSC and VHL renal epithelial cells in comparison to control cells. The majority of ribosomal protein genes are overexpressed in TSC cells and, to a lesser degree, in VHL cells. Results from different replicate (‘r’) and dye-flip experiments (‘d’) are presented. The dendrogram results from HCA conducted on the entire set of genes expressed in all 10 arrays. Red: upregulated; green: down-regulated.

FIG. 5A is a graphical representation of the proposed roles of certain proteins. FIG. 5B is a graphical representation of the regulation of HIF1α by TSC and VHL genes on a log₂ scale. Bars represent multiple direct and dye-flip replicates. FIG. 5C is a graphical representation of a real-time RT-PCR analysis of relevant genes in cells bearing mutant TSC and VHL. mRNA levels are expressed as percent amount relative to control cells from non-mutation carriers. Error bars represent the standard deviation of independent experiments performed with 2.5 or 10 ng of input test RNA.

FIG. 6 is a representation of the cluster analysis of genes whose expression is most divergent in the TSC and VHL datasets in comparison to normal control cells. Red: upregulated; green: down-regulated.

FIG. 7 is a schematic drawing of the mutation sites and the mutation cluster region of APC.

FIG. 8A is an image of hematoxylin and eosin stained human fibroblasts (1010) cells as a control. FIGS. 8B-8D are images of hematoxylin and eosin stained 333 cells grown in low serum (1% FBS; FIG. 8D), high serum (15% FBS; FIG. 8C), or low calcium (0.04 mM calcium; FIG. 8B).

FIG. 9 is a graph depicting the correlation of the expression profile of all genes in two replicates of human reference RNA processed independently on the same day using the NuGen Ovation™ Biotin System. The spots along the x-axis represent Poly A reverse transcription controls, which were spiked in reference RNA sample 1 but not in sample 2.

FIG. 10 is a graph depicting the correlation of the expression profile of expressed genes in two replicates of human reference RNA processed independently on the same day using the NuGen Ovation™ Biotin System.

FIGS. 11A-11F are representative electropherograms of total RNA (FIGS. 11A and 11B), amplified cDNA (FIGS. 11C and 11D), and fragmented-biotinylated cDNA (FIGS. 11E and 11F).

### DETAILED DESCRIPTION OF THE INVENTION

Evidence is presented herein which indicates that heterozygosity for cancer gene mutations leads to detectable molecular changes in clinically and phenotypically normal cells. These findings have implications for cancer prevention, early detection, and medical intervention, not only in predisposed individuals, but also for the general population. More specifically, the findings from the methods of the instant invention can be extrapolated from the particular cancer associated with the mutant cancer gene of the heterozygous carrier studied to all cancer types.

Alterations in the gene expression repertoire correlated with single-hit mutations of genes associated with cancer may represent the earliest molecular changes during tumorigenesis. Some of these early changes may directly bear on subsequent tumor induction. For example, even a small growth advantage, smaller than that of the homozygous mutant cell, could increase the number of “one-hit” cells available for conversion to “two-hit” tumor cells and, therefore, provide some selective advantage. Consequently, the observed “one-hit” effects may represent molecular targets for early detection and intervention with novel chemopreventive and/or chemotherapeutic agents. There may well be a further clarification of optimal targets at the “two-hit” stage of tumorigenesis in that those revealed in “one-hit” lesions would not include confounding secondary tumor effects. These “one-hit” cells may, therefore, provide important experimental reagents for the development of new chemoprevention agents, chemotherapeutic agents, and cancer detection strategies.

While the instant invention is exemplified, in part, hereinbelow by the study of one of the following heritable syndromes and corresponding gene mutations: familial adenomatous polyposis (APC), hereditary nonpolyposis colon cancer (MLH1), hereditary breast cancer (BRCA1 and 2), hereditary ovarian cancer (BRCA1 and 2), tuberous sclerosis (TSC1 and 2), and vonHippel-Lindau syndrome (VHL), the application of the instant invention extends to all cancers. As discussed hereinbelow, it has been ascertained that normal-appearing target tissue cells genetically predisposed to cancer reveal aberrations of gene expression that are related to heterozygosity for the predisposing mutation and to oncogenesis. The resulting data identifies new molecular targets and also provides intermediate endpoints for chemoprevention.

While the instant invention is exemplified, in part, hereinbelow by the study of the tumor suppressor gene related disorders TSC and VHL, which are two dominantly inherited syndromes associated with predisposition to renal tumors, the application of the instant invention extends to all disorders associated with DNA repair genes, oncogenes, and tumor suppressor genes such as, without limitation, BRCA1, BRCA2, EXT1, EXT2, DPC4, and CDKN2. TSC and VHL were selected, in part, because they allowed for the study of cells from persons with conditions that impart a dominantly heritable risk of cancer, but in whom tumor formation requires at least one somatic genetic event. Clinical prevention studies in such persons have the advantage that a high penetrance of cancer imparts a lower risk/benefit ratio for intervention than for random sampling of a population. Because such affected persons develop cancer at an earlier age than usual, fewer persons and less time are required to test a hypothesis. In the present study, it has been ascertained that normal-appearing target tissue cells genetically predisposed to cancer reveal aberrations of gene expression that are related to heterozygosity for the predisposing mutation and to oncogenesis. The resulting data identifies new molecular targets and intermediate endpoints for chemoprevention.

The results presented hereinbelow demonstrate significant differences in expression between normal and mutant cells. Interestingly, the spectrum of molecular changes associated with each heritable renal syndrome differed. Principal Component Analysis (PCA) of cells from nonmutation carriers and the two mutant conditions revealed separate and non-overlapping gene clusters indicating that gene expression patterns are altered and distinct for the two mutant conditions even in the nontumorigenic, heterozygous state. Some of these differences in expression are compatible, although not quantitatively identical, with known changes/properties in tumors that are homozygously mutant for the same two genes. This study shows that at least in some of the patients, heterozygosity in phenotypically normal epithelial cells leads to significant alterations in the expression of signaling pathways important in cancer.

Notably, for VHL, virtually all of the transcripts reported to be suppressed upon reintroduction of VHL cDNA into a homozygous mutant VHL renal carcinoma cell line were upregulated in heterozygous VHL renal epithelial cells (Zatyka et al. (2002) Cancer Res., 62:3803-11).

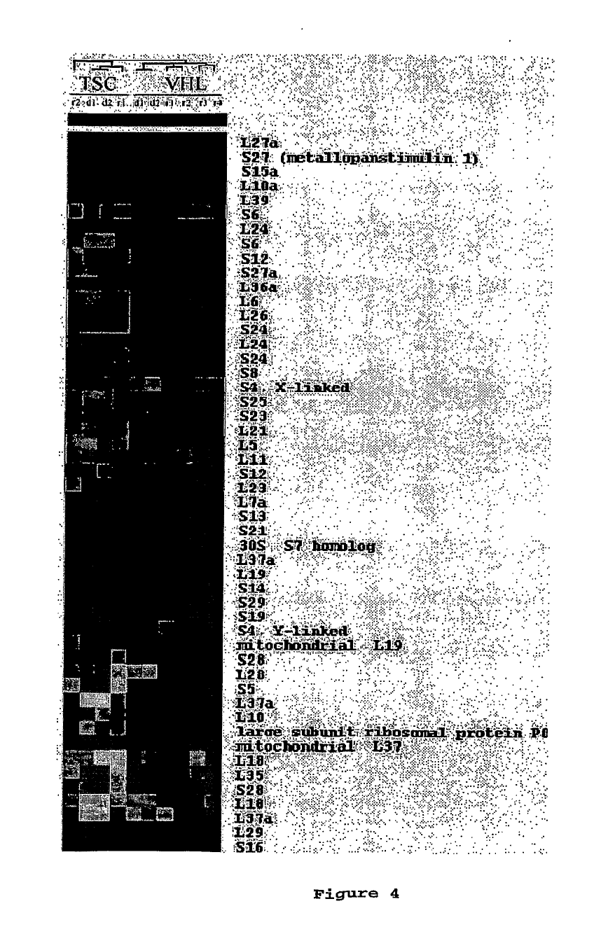

Although genotype information for the TSC patients enrolled in this study is not available, the gene products of TSC1 and TSC2, tubulin and hamartin, respectively, are known to interact. Both gene products downregulate protein synthesis and cell size/growth by inhibiting the PI3 kinase-AKT-mTOR-S6K axis. This inhibition appears to be compromised even in heterozygous TSC renal epithelial cells, in which increased expression of transcripts is detected for several factors involved in protein synthesis, including eukaryotic translation initiation factor 3 and several ribosomal proteins. Indeed, the studies described hereinbelow highlight transcriptional control of ribosomal protein gene expression by TSC1-TSC2 (FIG. 4). This is a unique finding because regulation of ribosomal protein gene expression was generally thought to occur only via post-transcriptional mechanisms in mammalian cells. On the other hand, it is well known that expression of yeast ribosomal protein genes is regulated at the transcriptional level in a rapamycin-sensitive pathway (Cardenas et al. (1999) Genes Dev., 13:3271-9; Powers et al. (1999) Mol. Biol. Cell, 10:987-1000). Four of the ribosomal protein genes upregulated in heterozygous TSC cells (L6, L21, S6 and S25) are indeed downregulated by the mTOR inhibitor rapamycin in yeast (Cardenas et al. (1999) Genes Dev., 13:3271-9; Powers et al. (1999) Mol. Biol. Cell, 10:987-1000). It is possible that kidney tumors in TSC patients display even more dramatic alterations in ribosomal protein gene transcription. Although less pronounced, upregulation of several ribosomal protein genes was also noted in heterozygous VHL cells (FIG. 4), suggesting that alterations in pathways of ribosome biosynthesis might be present in both TSC and VHL and could potentially represent a common characteristic of renal cancer from any cause.

Notably, a common feature of the activities of the TSC and VHL gene products appears to be suppression of the transcription factor HIF1, which is mediated post-transcriptionally by VHL, via ubiquitination and proteosomal degradation, and, at least in part, transcriptionally by TSC, likely via mTOR-mediated pathways. The present data are consistent with the notion that upregulation of HIF1 is important for renal cancer pathogenesis, via the transcriptional activation of mRNAs for VEGF, PDGF, TGFα, erythropoietin, and possibly other HIF1 transcriptional targets (Kim et al. (2003) Curr. Opin. Genet. Dev., 13:55-60; Linehan et al. (2003) J. Urol., 170:2163-72). The signature of upregulation of the mRNA for the HIF1α subunit is detectable in heterozygous TSC cells.

Statistical analysis of the microarray data also led to the identification of genes whose expression was most divergent between heterozygous TSC and VHL cells. These genes encode cytoskeletal, membrane and extracellular matrix-associated proteins. Dysregulation of expression in VHL cells may further support the role of these genes in inhibiting metastasis (Staller et al. (2003) Nature, 425:307-11). While the statistical analysis employed in the Examples provided hereinbelow facilitates the analysis of the microarray data, other statistical analyses are known in the art and can be used to analyze the microarray data produced in the methods of the instant invention. For example, the data pre-processing method Robust Multi-chip Average (RMA) can be employed with the instant invention. Details on RMA can be found at: 128.32.135.2/users/bolstad/ComputeRMAFAQ/ComputeRMAFAQ.html. RMA has been implemented in the open source R Bioconductor Suite which can be accessed at www.bioconductor.org, which provides a set of tools developed exclusively for genomics data analysis. For class comparisons, an exemplary method that can be used is the Local Pooled Error. This method is described in Jain et al. (Bioinformatics (2003) 19(15):1945-51). Other exemplary methods include, without limitation, standard ANOVA, Wilcoxon test and SAM. The method described in Storey & Tibshirani (PNAS (2003) 100(16):9440-5) has also been applied to estimate the False Discovery Rates.

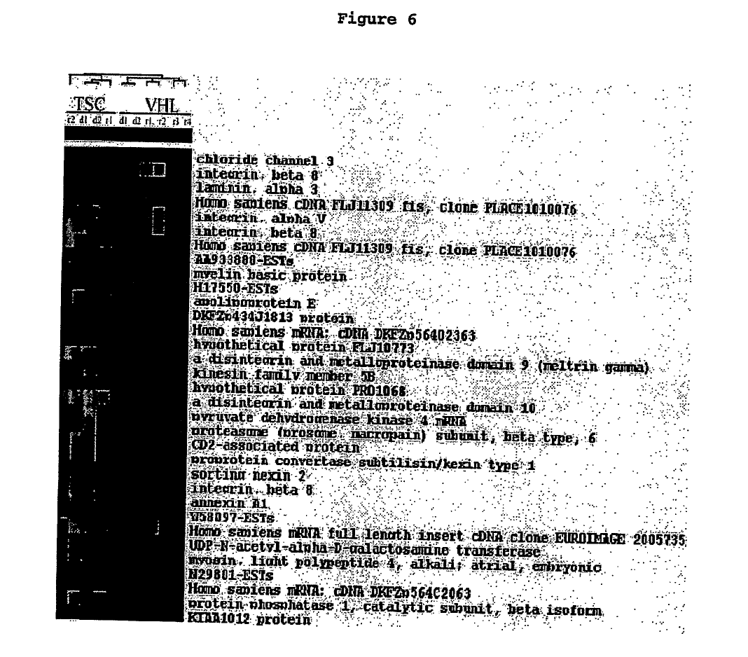

In accordance with another aspect of the invention, the markers or genetic signature provided can be used to diagnose a patient as a heterozygous carrier of a mutant gene associated with cancer. An exemplary method comprises obtaining a biological sample from the patient, determining the level of expression of the genetic signature in the biological sample, and comparing the level of expression of the genetic signature in the biological sample from the patient with the level of expression of the genetic signature in a normal individual and/or a known heterozygous carrier of the mutant cancer gene. In a particular embodiment, the gene associated with cancer is a tumor suppressor gene and is selected from the group consisting of TSC1, TSC2, and VHL. In another embodiment, the genetic signature comprises at least one, at least two of, at least three of, or all four of HSPA8, RAB2, NK4, and NDRG2. In another embodiment, the genetic signature comprises at least one, at least two, at least four, at least ten or more, or all of the genes provided in FIG. 4. In yet another embodiment, the genetic signature comprises at least one, at least two, at least four, at least ten or more, or all of the genes provided in FIG. 6. In still another embodiment, the genetic signature comprises at least one, at least two, at least four, at least ten or more, or all of the genes in the group consisting of HSPA8, RAB2, NK4, NDRG2, the genes provided in FIG. 4, and the genes provided in FIG. 6.

Identification of these differentially expressed nucleic acid molecules and proteins facilitates the development of screening assays to identify biomarkers and agents which mediate their activity. For example, cells can be created which express one or more of these molecules and treated with putative anti-cancer agents. Agents which modulate the biological activity of the differentially expressed genes may have efficacy as chemopreventive agents, chemotherapeutic agents, and early detection agents against any cancer including hereditary, familial, and sporadic cancers.

Described hereinbelow as an illustration of the instant invention are studies of Familial Adenomatous Polyposis (FAP) associated with germline mutation of the APC gene. Gene expression assays are utilized to characterize the differences between normal appearing cells grown in vitro from selected tissues of persons with or without such a mutation. These studies allow for the testing of the ability of putative preventive agents to attenuate, or even reverse, any observed differences. While the studies described hereinbelow were performed on colonic epithelial cells, colonic and skin fibroblasts, and blood lymphocytes, any cell type can be used. The fibroblasts were of particular interest because polyposis patients sometimes develop serious desmoid tumors.

The idea that there might be an effect of APC mutation in heterozygous cells had been previously shown for cells grown in vitro from FAP patients. Indeed, increased numbers of fibroblasts at confluence and an increased rate of transformation by Kirsten murine sarcoma virus were found (Kopelovich, L. (1977) Cancer 40:2534-2541). Further, Danes et al. reported a considerable increase in tetraploidy for colonic epithelial cells (Danes, B. S. (1978) Cancer 41:2330-2334). Both of these reports indicate “one-hit” effects. Such an effect could be associated with an increased rate of emergence of clones with second hits that render a cell homozygous for mutation or loss of a gene associated with cancer such as a tumor suppressor gene such as APC. Thus, the first event could influence the rate at which a benign polyp would appear. If true, agents that inhibit the heterozygous effects could delay polyp formation.

These considerations may apply to other genes whose germline mutations create a dominantly inherited predisposition to cancer. Many of these are tumor suppressor genes (including, without limitation, BRCA1, BRCA2, EXT1, EXT2, DPC4, and CDKN2), some are oncogenes (including, without limitation, RET, MET, and Kin), and some are DNA repair genes (including, without limitation, MSH2, MLH1, BRCA1, and BRCA2). Therefore, other mutations were studied as well. Further, it was determined that it could be helpful to study two different mutant genes, along with the controls, for each site. For colon, APC and MLH1, representing two different categories in the above list, were selected. MLH1 was also of particular interest because it is also found in a somatically mutant form in some nonhereditary colon cancers and it can affect methylation of other genes. BRCA1 and BRCA2 were also selected because these cancer-predisposing mutations have the highest incidence among dominant cancer genes.

In another aspect of the instant invention, this study allows for the identification of potential molecular targets for therapeutic intervention in individuals known to be at increased risk for cancer. The greatest opportunity to identify very early alterations is provided by dominantly inherited cancer syndromes whose responsible germinally mutant genes have been characterized. Select tissues were obtained from individuals with six representative heritable cancer syndromes. Thus, the present studies involved no less than six different genes—APC, MLH1, BRCA1, BRCA2, TSC, and VHL—and four different target organs—colon, breast, ovary, and kidney. The experimental approach generally consisted of collecting nonneoplastic cells from the relevant tissues, establishing primary cell strains in vitro, extracting RNA from the cultured cells, and screening for differences in gene expression (either between mutant and control cell strains or between cell strains carrying two different types of mutations) using microarray technology.

### I. Definitions

The following definitions are provided to facilitate an understanding of the present invention.

“Nucleic acid” or a “nucleic acid molecule” as used herein refers to any DNA or RNA molecule, either single or double stranded and, if single stranded, the molecule of its complementary sequence in either linear or circular form. In discussing nucleic acid molecules, a sequence or structure of a particular nucleic acid molecule may be described herein according to the normal convention of providing the sequence in the 5′ to 3′ direction. With reference to nucleic acids of the invention, the term “isolated nucleic acid” is sometimes used. This term, when applied to DNA, may refer to a DNA molecule that is separated from sequences with which it is immediately contiguous in the naturally occurring genome of the organism in which it originated. For example, an “isolated nucleic acid” may comprise a DNA molecule inserted into a vector, such as a plasmid or virus vector, or integrated into the genomic DNA of a prokaryotic or eukaryotic cell or host organism. Alternatively, this term may refer to a DNA that has been sufficiently separated from (e.g., substantially free of) other cellular components with which it would naturally be associated. “Isolated” is not meant to exclude artificial or synthetic mixtures with other compounds or materials, or the presence of impurities that do not interfere with the fundamental activity, and that may be present, for example, due to incomplete purification.

With respect to single stranded nucleic acids, particularly oligonucleotides, the term “specifically hybridizing” refers to the association between two single-stranded nucleotide molecules of sufficiently complementary sequence to permit such hybridization under pre-determined conditions generally used in the art (sometimes termed “substantially complementary”). In particular, the term refers to hybridization of an oligonucleotide with a substantially complementary sequence contained within a single-stranded DNA molecule of the invention, to the substantial exclusion of hybridization of the oligonucleotide with single-stranded nucleic acids of non-complementary sequence. Appropriate conditions enabling specific hybridization of single stranded nucleic acid molecules of varying complementarity are well known in the art.

For instance, one common formula for calculating the stringency conditions required to achieve hybridization between nucleic acid molecules of a specified sequence homology is set forth below (Sambrook et al. (1989) Molecular Cloning—A Laboratory Manual, 2nd Edition, Cold Spring Harbor Laboratory Press, New York):

Tₘ=81.5C16.6 Log [Na+]+0.41(% G+C)−0.63(% formamide)−600/#bp in duplex

As an illustration of the above formula, using [Na+]=[0.368] and 50% formamide, with GC content of 42% and an average probe size of 200 bases, the Tₘ is 57° C. The Tₘ of a DNA duplex decreases by 1-1.5° C. with every 1% decrease in homology. Thus, targets with greater than about 75% sequence identity would be observed using a hybridization temperature of 42° C.

The stringency of the hybridization and wash depend primarily on the salt concentration and temperature of the solutions. In general, to maximize the rate of annealing of the probe with its target, the hybridization is usually carried out at salt and temperature conditions that are 20-25° C. below the calculated Tₘ of the hybrid. Wash conditions should be as stringent as possible for the degree of identity of the probe for the target. In general, wash conditions are selected to be approximately 12-20° C. below the Tₘ of the hybrid. In regards to the nucleic acids of the current invention, a moderate stringency hybridization is defined as hybridization in 6×SSC, 5×Denhardt's solution, 0.5% SDS and 100 μg/ml denatured salmon sperm DNA at 42° C., and washed in 2×SSC and 0.5% SDS at 55° C. for 15 minutes. A high stringency hybridization is defined as hybridization in 6×SSC, 5×Denhardt's solution, 0.5% SDS and 100 μg/ml denatured salmon sperm DNA at 42° C., and washed in 1×SSC and 0.5% SDS at 65° C. for 15 minutes. A very high stringency hybridization is defined as hybridization in 6×SSC, 5×Denhardt's solution, 0.5% SDS and 100 μg/ml denatured salmon sperm DNA at 42° C., and washed in 0.1×SSC and 0.5% SDS at 65° C. for 15 minutes. When using microarrays obtained from a commercial vendor, hybridization conditions recommended by the manufacturer may be employed.

The term “primer” as used herein refers to an oligonucleotide, either RNA or DNA, either single-stranded or double-stranded, either derived from a biological system, generated by restriction enzyme digestion, or produced synthetically which, when placed in the proper environment, is able to functionally act as an initiator of template-dependent nucleic acid synthesis. When presented with an appropriate nucleic acid template, suitable nucleoside triphosphate precursors of nucleic acids, a polymerase enzyme, suitable cofactors and conditions such as appropriate temperature and pH, the primer may be extended at its 3′ terminus by the addition of nucleotides by the action of a polymerase or similar activity to yield a primer extension product. The primer may vary in length depending on the particular conditions and requirement of the application. For example, in diagnostic applications, the oligonucleotide primer is typically 15-25 or more nucleotides in length. The primer must be of sufficient complementarity to the desired template to prime the synthesis of the desired extension product, that is, to be able to anneal with the desired template strand in a manner sufficient to provide the 3′ hydroxyl moiety of the primer in appropriate juxtaposition for use in the initiation of synthesis by a polymerase or similar enzyme. It is not required that the primer sequence represent an exact complement of the desired template. For example, a non-complementary nucleotide sequence may be attached to the 5′ end of an otherwise complementary primer. Alternatively, non-complementary bases may be interspersed within the oligonucleotide primer sequence, provided that the primer sequence has sufficient complementarity with the sequence of the desired template strand to functionally provide a template-primer complex for the synthesis of the extension product.

The term “probe” as used herein refers to an oligonucleotide, polynucleotide or DNA molecule, whether occurring naturally as in a purified restriction enzyme digest or produced synthetically, which is capable of annealing with or specifically hybridizing to a nucleic acid with sequences complementary to the probe. The probes of the present invention refer specifically to the oligonucleotides attached to a solid support in the DNA microarray apparatus such as the glass slide. A probe may be either single-stranded or double-stranded. The exact length of the probe will depend upon many factors, including temperature, source of probe and use of the method. For example, for diagnostic applications, depending on the complexity of the target sequence, the oligonucleotide probe typically contains 15-25 or more nucleotides, although it may contain fewer nucleotides. The probes herein are selected to be complementary to different strands of a particular target nucleic acid sequence. This means that the probes must be sufficiently complementary so as to be able to “specifically hybridize” or anneal with their respective target strands under a set of pre-determined conditions. Therefore, the probe sequence need not reflect the exact complementary sequence of the target. For example, a non-complementary nucleotide fragment may be attached to the 5′ or 3′ end of the probe, with the remainder of the probe sequence being complementary to the target strand. Alternatively, non-complementary bases or longer sequences can be interspersed into the probe, provided that the probe sequence has sufficient complementarity with the sequence of the target nucleic acid to anneal therewith specifically.

The term “gene” refers to a nucleic acid comprising an open reading frame encoding a polypeptide, including both exon and (optionally) intron sequences. The nucleic acid may also optionally include non coding sequences such as promoter or enhancer sequences. The term “intron” refers to a DNA sequence present in a given gene that is not translated into protein and is generally found between exons.

The term “promoter” or “promoter region” generally refers to the transcriptional regulatory regions of a gene. The “promoter region” may be found at the 5′ or 3′ side of the coding region, or within the coding region, or within introns. Typically, the “promoter region” is a nucleic acid sequence which is usually found upstream (5′) to a coding sequence and which directs transcription of the nucleic acid sequence into mRNA. The “promoter region” typically provides a recognition site for RNA polymerase and the other factors necessary for proper initiation of transcription.

A “vector” is a replicon, such as a plasmid, cosmid, bacmid, phage or virus, to which another genetic sequence or element (either DNA or RNA) may be attached so as to bring about the replication of the attached sequence or element.

An “expression operon” refers to a nucleic acid segment that may possess transcriptional and translational control sequences, such as promoters, enhancers, translational start signals (e.g., ATG or AUG codons), polyadenylation signals, terminators, and the like, and which facilitate the expression of a polypeptide coding sequence in a host cell or organism.

As used herein, the term “biological sample” refers to a subset (e.g., portion or extract) of the tissues of a biological organism, its cells (or lysates thereof), or component parts (e.g. biological fluids such as, without limitation, blood, urine, serum, ascites, saliva, plasma, breast fluid, and peritoneal fluid). The biological sample may be freshly harvested or preserved (e.g., frozen, fixed, and/or paraffin embedded). The biological sample may be a surgical biopsy. In a preferred embodiment, the patient is human. The biological sample may be a skin biopsy. In a preferred embodiment, the biological sample is obtained from the patient by measures with minimal or no invasiveness. For example, the drawing of blood or obtaining a skin biopsy is considered minimally invasive while the use of urine, semen, or saliva may be considered as noninvasive.

The term “patient” as used herein refers to human or animal subjects.

The term “detectably label” is used herein to refer to any substance whose detection or measurement, either directly or indirectly, by physical or chemical means, is indicative of the presence of the target bioentity. Representative examples of useful detectable labels, include, but are not limited to the following: molecules or ions directly or indirectly detectable based on light absorbance, fluorescence, reflectance, light scatter, phosphorescence, or luminescence properties; molecules or ions detectable by their radioactive properties; molecules or ions detectable by their nuclear magnetic resonance or paramagnetic properties. In a particular embodiment, the detectable label may be Cy5 or Cy3. Included among the group of molecules indirectly detectable based on light absorbance or fluorescence, for example, are various enzymes which cause appropriate substrates to convert, e.g., from non-light absorbing to light absorbing molecules, or from non-fluorescent to fluorescent molecules.

As used herein, a “microarray” refers a plurality of nucleic acid molecules attached to a support where each of the nucleic acid members is attached to a solid support in a unique pre-selected region. In a particular embodiment, the nucleic acid member attached to the surface of the support is DNA (e.g., cDNA). Exemplary microarrays are commercially available from such companies as Affymetrix Inc. (Santa Clara, Calif.), Nanogen (San Diego, Calif.) and Protogene Laboratories (Palo Alto, Calif.). In a particular, embodiment, the microarray is representative of the entire human genome, e.g. the Affymetrix chip.

The term “solid support” refers to any surface onto which targets, such as nucleic acids, may be immobilized for conducting assays and reactions. Exemplary solid supports include, without limitation, paper, nylon or other type of membrane, filter, chip, glass (e.g., glass slide), beads, and plastic.

As used herein, the term “heterozygous” refers to having different alleles at a corresponding chromosomal locus.

The term “chemopreventive,” as used herein, refers to a composition that is useful in preventing cancer.

The term “chemotherapeutic,” as used herein, refers to a composition that is useful in treating cancer.

A “marker,” as used herein, refers to a gene or product of gene expression (e.g., RNA or protein) which is characteristic of a particular cell type. Notably, a marker can be expressed in normal cells, but can be characteristic of a particular cell type (e.g. heterozygous for mutant gene associated with cancer) by, for example, its over-expression or under-expression as compared to its expression in normal cells.

Cancers of the instant invention may be generally characterized as being either hereditary (or inherited), familial, or sporadic. A cancer may be defined as hereditary (or inherited) when predisposition to cancer is inherited or vertically transmitted according to a pattern that follows Mendelian laws (e.g., autosomal dominant inheritance, autosomal recessive inheritance, and sex-linked (X-chromosome or Y-chromosome) inheritance. A cancer may be defined as familial when aggregation of cancer cases is detected but genetic predisposition to cancer does not follow Mendelian laws. In this case, genetic predisposition is multi-factorial as a consequence of multiple gene interactions as well as gene-environment interactions. A sporadic cancer may be a cancer that occurs in the apparent absence of any genetic (either hereditary or familial) predisposition.

The terms “gene associated with cancer” and “cancer gene” refer to a gene whose altered expression and/or altered (e.g., mutant) expression product (e.g., mRNA or protein) within a cell somehow disrupts normal cellular function or control and effects the formation of an abnormal mass. Exemplary genes associated with cancer include, without limitation, proto-oncogenes, oncogenes, DNA repair genes, and tumor suppressor genes.

As used herein, an “oncogene” generally refers to a polynucleotide containing at least one open reading frame that is capable of transforming a normal cell into a cancerous tumor cell. Oncogenes are often altered forms of “proto-oncogenes” that are incapable of cell transformation when unaltered and expressed at the level present in a non-cancer cell.

The term “tumor suppressor gene” refers to a gene whose expression within a cell suppresses the ability of such cells to grow spontaneously and form an abnormal mass. The term “mutant tumor suppressor gene” refers to a non-functional tumor suppressor gene (e.g., incapable of inhibiting a cell from behaving as and/or becoming a tumor cell), usually by modification of the gene, such as by methylation, mutation, and/or deletion of all or part of the gene.

The term “genetic signature,” as used herein, refers to a subset of nucleic acid molecules (e.g., genes) which are differentially expressed (e.g., overexpressed or underexpressed) between heterozygous carriers of mutant tumor suppressor genes and normal individuals. A “genetic signature” facilitates clinical discrimination between a heterozygous carrier and a normal individual. A “genetic signature” may comprise a plurality of differentially expressed nucleic acid molecules. Optionally, the nucleic acids comprising the genetic signature are affixed to a solid support.

### II. Detection

The markers of the instant invention may be detected in a biological sample by any method known in the art. For example, methods for the detection of the polynucleotides (e.g., genes, cDNA, and mRNA) of the markers include, without limitation, in situ hybridization, Northern blot, Southern blot, microarray analysis, single-stranded conformational polymorphism analyses (SSCP), and nucleic acid amplification techniques such as PCR (e.g., quantitative PCR) and RT-PCR. Additionally, the protein expressed by the markers of the instant invention may be detected by methods such as, without limitation, immunohistochemistry, immunoblot, radioimmunoassays (RIA), enzyme-linked immunosorbent assay (ELISA), protein array, antibody array (see, e.g., Haab, B. B. (Proteomics (2003) 3:2116-2122), fluorescent resonance energy transfer (FRET) assays, and/or detecting modification of a substrate by the cancer marker.

In a preferred embodiment, the markers are detected by microarray analysis, more specifically, by cDNA microarray analysis. Microarray analysis allows for the simultaneous analysis of the expression of multiple genes within a biological sample. Accordingly, it is useful for generating gene expression profiles and identifying a genetic signature for a particular biological sample. Typically, to perform cDNA microarray analysis, RNA is isolated from a biological sample and cDNA is synthesized from the RNA according to standard methods (see, for example, Sambrook et al., Molecular cloning, a laboratory manual. 2^{nd} ed. Cold Spring Harbor Laboratory, Cold spring Harbor, N.Y., 1989; Ausubel et al. (2005) (Current Protocols in Molecular Biology, John Wiley and Sons, New York). The labeled probes are then allowed to hybridize with a cDNA microarray containing, preferably, at least 3000 cDNAs, at least 10,000 cDNAs, at least 40,000 cDNAs, or more. Relative over-expression or under-expression of the mRNA in the biological sample, as assessed by the hybridization, can be measured against the expression of the mRNA in a normal individual, either as determined empirically or from a reference standard.

In a particular embodiment, the microarray analyses described by Upson et al. (J. Cell. Physiol. (2004) 201:366-73) and Stoyanova et al. (J. Cell. Physiol. (2004) 201:359-65) can be employed in the methods of the instant invention.

### III. Therapeutics

The instant invention also encompasses the use of the marker genes and their expression products as targets for the development of therapeutics. The invention specifically encompasses agonists and antagonists to the marker genes and their expression products. For markers that are overexpressed in heterozygous carriers of a mutant gene associated with cancer, agents which inhibit their activity are desired. Similarly, for markers that are underexpressed in heterozygous carriers of a mutant gene associated with cancer, agents which increase or induce their activity are desired. Such agents (e.g., antagonists and agonists) include antibodies (e.g., therapeutic antibodies (see, generally, Herceptin™ (Trastuzumab))), peptides, peptidomimetics, ligands, small molecules, inhibitory nucleic acid molecules (e.g., antisense nucleic acid molecules, ribozymes, siRNAs, shRNAs, and the like, directed against, for example, the marker or mutant tumor suppressor gene) nucleic acid molecules encoding the marker, and nucleic acid molecules encoding the wild-type (i.e., non-mutant) tumor suppressor gene (see, generally, Ausubel et al. (2005) (Current Protocols in Molecular Biology, John Wiley and Sons, New York).

The discovery of therapeutics against at least one marker facilitates the development of pharmaceutical compositions useful for treatment of the disease associated with the mutant gene correlated with cancer as well as all potentially all other cancers such as corresponding sporadic forms of cancer. These pharmaceutical compositions may comprise at least one therapeutic agent (e.g., an agonist or antagonist) of the instant invention and a pharmaceutically acceptable carrier.

### IV. Kits

Kits are provided for practicing the methods of the instant invention. For example, the kits may be used assessing the presence of the markers of the instant invention in a biological sample from a patient and thereby diagnosing the patient as a heterozygous carrier of a mutant gene associated with cancer (e.g., DNA repair gene, oncogene, proto-oncogene, tumor suppressor gene).

The kits of the instant invention comprise at least one agent capable of binding specifically with a marker nucleic acid molecule or polypeptide. In a particular embodiment, the agents are nucleic acid molecules (e.g., cDNAs) attached to a microarray. In another embodiment, the kits comprise the microarrays described hereinabove.

The kit may contain further components such as buffers suitable for specifically binding complementary nucleic acid molecules or for binding an antibody with a protein with which it specifically binds. The kit may also further comprise at least one sample container. The kits may also further comprise instructional material. The kits may also further comprise primers, optionally detectably labeled, specific for the markers on the microarray to allow for amplification of the markers and/or the generation of cDNA from marker mRNA.

The methods of the instant invention encompass the measurement of the increased or decreased expression of at least one marker for the diagnosis of a patient as a heterozygous carrier of a mutant gene associated with cancer. The methods may also comprise the determination of the level of expression of the marker in a biological sample from a normal patient (i.e., a patient that does not have a mutant tumor suppressor gene) and/or the level of expression of the marker in a biological sample from a patient known to be a heterozygous carrier of a mutant gene associated with cancer. Accordingly, the instant kits may also further comprise biological samples from normal patients and/or heterozygous carriers of a mutant gene associated with cancer as negative and positive controls, respectively. In another embodiment, the kits may comprise, in the alternative or in addition to the above biological samples, isolated marker nucleic acid molecules at a known concentration. Such kits may further comprise information on the average range of expression for the marker nucleic acid molecule in normal patients and/or heterozygous carriers of a mutant gene associated with cancer for comparison to the level of expression of the marker in a biological sample.

In another embodiment of the instant invention, kits are provided to facilitate screening assays to identify agents which modulate (e.g., increase or decrease) the activity of differentially expressed nucleic acid molecules and proteins. The kits comprise cells, as described hereinabove, which express one or more of the nucleic acid molecules identified as being differentially expressed in heterozygous carriers of mutant genes associated with cancer (e.g., recombinant cells transformed with at least one expression vector comprising differentially expressed nucleic acid molecules). Methods for transforming (e.g., stably) cells with a nucleic acid molecule of interest (e.g., in a vector) are known in the art (see, e.g., Ausubel et al. (2005) (Current Protocols in Molecular Biology, John Wiley and Sons, New York). The kits may further comprise media for maintaining the cells. The kits may also further comprise instruction material, particularly instruction material directed to performing screening assays with the provided cells expressing the differentially expressed nucleic acid molecules. For example, if the differentially expressed nucleic acid molecule is a ribosomal protein, the instructional material can direct the user to monitor translation events in the cell and/or global protein expression in the cell before and after the administration of the agents (e.g., library of compounds) to be screened to determine the agents' ability to modulate the differentially expressed nucleic acid molecule.

The examples set forth below are provided to better illustrate certain embodiments of the invention. They are not intended to limit the invention in any way.

### Example I

### Methods

Subject Recruitment. Subjects who had been diagnosed previously with the heritable TSC and VHL syndromes were recruited with the approval of the Fox Chase Cancer Center (FCCC) Institutional Review Board, irrespective of gender, race and age. TSC cases (N=6) were obtained from hospitals throughout the United States, while all VHL (N=6) carriers were patients at the National Cancer Institute (NCI). Phenotypically normal-appearing renal tissue was collected from sporadic renal cancer patients (N=6) undergoing nephrectomy at FCCC (nonmutation carrier controls).

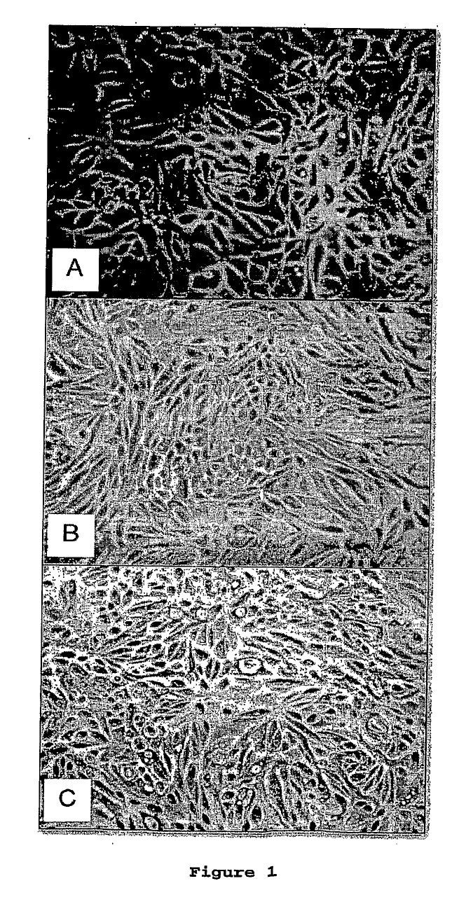

Epithelial Cell Cultures. Tissues were minced between two scalpel blades and incubated in 15 ml of 0.2% collagenase (Sigma, St. Louis, Mo.) prepared in serum-free F-12 media containing 10 μg/ml ciprofloxacin, 100 U/ml penicillin and 100 μg/ml streptomycin for 1-2 hours at 37° C. in a rocking water bath. Following digestion, the mixture was centrifuged for 10 minutes at 1500 rpm, and the resulting pellet was washed three times with F-12 media containing antibiotics and transferred to a swine gelatin-coated T25 flask containing 2.5 ml of serum-free ACL-4 media supplemented with 10 μg/ml epidermal growth factor, 1.6 μM ferrous sulfate and 10 nM cholesterol. Cells were maintained in the presence of 10 μg/ml ciprofloxacin for the first 4 weeks in culture. All experiments were performed with early passage cultures (passages 2-5). Early passage renal epithelial cells from VHL, TSC and control patients grew robustly in culture with a doubling time of 48 hours. Cells did not show any overt signs of transformation and senesced at passage 7-10. Cultures from mutation carriers were phenotypically indistinguishable from those derived from control nonmutation carriers (FIG. 1).

RNA Extraction. Total RNA was prepared from renal epithelial cells by extraction in guanidinium isothiocyanate-based buffer containing β-mercaptoethanol and acid phenol (Chomczynski et al. (1987) Anal. Biochem., 162:156-9). RNA integrity was evaluated by formaldehyde-agarose gel electrophoresis and A₂₆₀/A₂₈₀ ratios. Equal aliquots of total RNA from six individuals undergoing renal surgery but having no known genetic predisposition to renal carcinoma (controls), six VHL patients and six TSC patients were combined to generate pools for microarray analysis.

RNA Amplification. For RNA amplification, a modification of Eberwine's protocol was used, as previously described (Van Gelder et al. (1990) Proc. Natl. Acad. Sci., 87:1663-7; Baugh et al. (2001) Nucleic Acids Res., 29:E29; Stoyanova et al. (2004) J. Cell. Physiol., 201:359-65). Briefly, double-stranded cDNA (ds-cDNA) was synthesized from each of the pooled total RNAs (200 ng/sample×six samples) using the Superscript Double-Stranded cDNA Synthesis Custom Kit (Invitrogen, Carlsbad, Calif.) and an oligo-(dT)₂₄-T7 primer: 5′-AAACGACGGCCAGTGAATTGTAATACGACTCACTATAGGCGC-(dT)₂₄-3′. The ds-cDNA was extracted once each with phenol/chloroform and chloroform and purified with Microcon YM-100 spin columns (Millipore, Bedford, Mass.) prior to amplification by T7 RNA polymerase.

The Ampliscribe T7 transcription kit (Epicentre Technologies, Madison, Wis.) was used for one round of RNA in vitro transcription by T7 RNA polymerase. The resulting amplified, complementary RNA (aRNA) was extracted and washed in Microcon YM-100 spin columns.

Amplified RNA Probe Preparation. Amplified RNAs were used to synthesize cDNA probes labeled by indirect (amino-allyl) incorporation of Cy3 and Cy5, as previously described (Stoyanova et al. (2004) J. Cell. Physiol., 201:359-65). Probes were prepared for two pairs of replicates, including dye-flips. For each of the six reactions (two for TSC, two for VHL, and two for controls), 4 μg of aRNA, 10 U of random hexamers, and 400 U of Superscript II (200 U/μL) (Invitrogen) were used (Stoyanova et al. (2004) J. Cell. Physiol., 201:359-65). After alkaline hydrolysis of residual RNA, the cDNA probes were ethanol-precipitated overnight at −20° C. The next day, the reactions were centrifuged at 14,000×g for 30 minutes at 4° C. The supernatant was removed, and the pellets were washed with 70% ice-cold ethanol and air-dried.

The cDNA pellets were resuspended in 15 μL of IX coupling buffer (0.2 M NaHCO₃, pH 9.0) and divided into two 7.5 μL aliquots. Each aliquot was mixed with 2.5 μL of prepared Cy3 or Cy5, respectively, and incubated at room temperature in the dark for 1 hour. Forty microliters of 100 mM NaOAc, pH 5.2, was added to each reaction, and the labeled probes were purified using the QIAquick PCR purification kit (Qiagen, Inc., Valencia, Calif.) as described previously (Stoyanova et al. (2004) J. Cell. Physiol., 201:359-65).

The concentration of the Cy3- or Cy5-labeled cDNA probes was determined in an ND-1000 Spectrophotometer (NanoDrop Technologies, Inc., Montchanin, Del.). Eighty picomoles of each probe were mixed with 10 μg of poly-A DNA and 10 μg of human Cot I DNA (Invitrogen) and dried in a vacuum centrifuge. The resulting pellets were resuspended in 25 μL of 1× hybridization buffer (50% formamide, 5×SSC, 0.1% SDS) and divided into two 12.5 μL aliquots. Each dye-labeled aliquot, corresponding to 40 picomoles, was then mixed with 12.5 μL of the opposite dye-labeled aliquot from the opposing genotype and heated at 100° C. for 3 minutes prior to hybridization with human 40,000 (40K) cDNA microarrays.

Microarray Hybridization. Approximately 40,000 human cDNA clones (40K set, Research Genetics, Huntsville, Ala.) were PCR-amplified, with product generation confirmed by agarose gel electrophoresis. The clones were printed onto three polylysine-coated slides, two with 15,552 and one with 10,368 spots, in the DNA Microarray Facility of the FCCC. Hybridization was performed in a 42° C. water bath for 16-20 hours under a glass cover slip (Corning, Acton, Mass.) in ArrayIT hybridization cassettes (TeleChem International, Inc., Sunnyvale, Calif.). After D hybridization, the slides were washed twice (10 minutes each) at room temperature in pre-heated (55° C.) 1×SSC, 0.2% SDS and pre-heated (55° C.) 0.1×SSC, 0.2% SDS, followed by 0.1×SSC (1 minute) and dH₂O (10 s). Slides were fast-dried by centrifugation in a swinging bucket rotor at 650 rpm for 5 minutes in an Eppendorf MDL5810R centrifuge.

Array Scanning and Image Analysis. The slides were scanned with a GMS 428 Scanner (Affymetrix, Santa Clara, Calif.) at select laser intensity and photomultiplier tube voltage parameters, which allowed the analysis of each slide over a full dynamic range in the respective channel. Image segmentation and spot quantification were performed with the ImaGene software (BioDiscovery, Marina del Rey, Calif.).

Calculation of Gene Expression Profiles. Initially, expression data from the two channels of each array were analyzed independently in order to identify genes with intensities above a threshold. The threshold was set at 2 standard deviations of the background noise above the background (the mean pixel intensities of the spot and the area surrounding the spot, or local background were used throughout the study). Genes with spot intensities above the set threshold were considered expressed. The values for the local background were subtracted from the signal intensities of each spot. Data from each of the three slides were individually normalized for the different incorporation rates of Cy3 and Cy5 using polynomial fit to the M versus A plot. Only spots with intensities above the threshold in both channels of the array were used for normalization. Finally, for these spots, the log₂ of the ratio of the intensities of channel 2 (Cy5) over channel 1 (Cy3) was calculated. The log₂ ratio of the remaining (i.e., non-expressed) genes was set to 0. The reciprocal value of the ratios was used for the dye-flip experiments.

Quality Control Procedures. The quality of the microarray images was examined. In cases with insufficient intensities in one or both channels, the experiment was repeated. As part of the quality-control procedures, a total of 834 spots (out of 40K) that were blank (n=672) or spotted with vehicle only (50% DMSO, n=162) served as negative (empty) controls. The reproducibility of replicate and dye-flip experiments was assessed by calculating the Pearson Correlation coefficient of the estimated ratios of genes expressed in all arrays in the series (Stoyanova et al. (2004) J. Cell. Physiol., 201:359-65).

Statistical Analysis. The initial statistical analysis addressed the question of whether there are genes that are differentially expressed in the mutant cells as compared to nonmutated controls. For each gene, the null hypothesis, that the mean ratios of the data are 1 (on log₂ scale, 0), was tested using a two-sided, one-sample t-test. The t-statistic was calculated for genes with non-zero values in all arrays for each syndrome. Genes differentially expressed in the mutant cells vs. the normal controls (p<0.001) for each syndrome were separated into two groups: up or downregulated in either TSC or VHL, and also concurrently up and downregulated in both TSC and VHL relative to normal cells. The identity and function of the genes in these lists were examined by querying the SOURCE database (Diehn et al. (2003) Nucleic Acids Res., 31:219-23). The log₂ values of the expression ratios of genes concurrently expressed in all replicates were averaged and the histograms of their distributions characterized.

Principal Component Analysis (PCA) was applied to assess the overall differences between samples and their replicates. PCA is an invaluable aid in the exploration of large genomic datasets, allowing representation of complex data in lower dimensional space, defined by the Principal Components (PCs) (Misra et al. (2002) Genome Res., 12:1112-20). PCA was applied to a data matrix containing the gene expression ratios across all replicate and dye-flip experiments. Thus, each array is represented as a point in a coordinate system, defined by the PCs. The distance between replicate samples reflects the experimental error. The method has been used previously in the analysis of microarray data from time-course experiments, normalization of gene expression ratios obtained from two different microchips of two-channel arrays, and for partitioning large-sample microarray-based gene expression profiles (Alter et al. (2000) Proc. Natl. Acad. Sci., 97:10101-6; Alter et al. (2003) Proc. Natl. Acad. Sci., 100:3351-6; Nielsen et al. (2002) Lancet, 359:1301-7; Peterson et al. (2003) Comput. Methods Programs Biomed., 70:107-19).

To identify clusters of genes simultaneously up and downregulated in TSC and VHL, Hierarchical Cluster Analysis (HCA) was applied to the data matrix described above. HCA permits the grouping of data points in a multi-dimensional space and is also used frequently in the analysis of microarray data (Eisen et al. (1998) Proc. Natl. Acad. Sci., 95:14863-8). The results of the clustering algorithm are displayed as a dendrogram in which the branch heights are proportional to the distances between the various clusters, and hence, the height of the branches linking one sample to the next is an inverse measure of their similarity.

Real-time Quantitative RT-PCR. Real-time reverse transcriptase (RT)-PCR was performed to determine gene expression levels. The primer and probe sequences used for real-time RT-PCR are listed in Table 1. Fluorogenic Taqman assays (Applied Biosystems, Foster City, Calif.) were run on a SmartCycler (Cepheid) instrument. For NK4, RPL6, and PCNA, Assay-on-Demand Gene Expression kits (Applied Biosystems) were used. The Taqman set for the ACTB gene was constructed based on sequences that are available publicly. For all other genes, primers and probes were designed using Primer Express™ version 1.5 software (Applied Biosystems). All probes were synthesized in the Fannie Rippel Biotechnology Facility at FCCC and labeled at the 5′ and 3′ ends with the reporter dye FAM (6-carboxy-fluorescein) (Glenn Research) and the quencher dye (Black Hole Quencher (BHQ1)) (Biosearch Technologies, Novato, Calif.), respectively.

Total RNA (100 ng) from each pool (mutant or control) was reverse-transcribed using the Super Script™ First Strand Synthesis Kit for RT-PCR (Invitrogen) or the iScript™ cDNA Synthesis Kit (Bio-Rad, Hercules, Calif.), according to the manufacturer's instructions, except that priming was performed using a mixture of oligo dT (0.5 μg) and random decamers (0.5 μg). For each sample, an RT-minus control (RNA samples treated similarly but without the addition of RT) was included to provide a negative control for subsequent PCR.

Platinum Taq (Invitrogen) was used for PCR. The concentrations of primers and probe were 400 and 100 nM, respectively. For each RNA sample, PCR reactions were performed in duplicate with two different amounts of starting RNA (1 and 0.25 ng for ACTB, KRT18, HSPA8, NK4; 10 and 2.5 ng for all of the other genes). The amplification plots were used to determine the cycle threshold (Ct). For each sample, the slope of the curve Ct=f (log x) where x=starting RNA in ng was calculated.

TABLE 1
Primer sets used for reat-time
quantitave RT-PCR.

| Gene | | | |
|---|---|---|---|
| name | Accession # | | Sequence (5′→3′) |
| ACTB | NM_001101 | F | CCCTGGCACCCAGCAC |
| | | R | GCCGATCCACACGGAGTAC |
| | | P | ATCAAGATCATTGCTCCTCCGAGCGC |
| KRT18 | M26326 | F | GAGGCTGAGATCGCCACCT |
| | | R | TGTCCAAGGCATCACCAAGA |
| | | P | CCGCCGCCTGCTGGAAGATG |
| HSPA8 | NM_153201 | F | TGGCTTCCTTCGTTATTGGA |
| | | R | CAACTGCAGGTCCCTTGGAC |
| | | P | CCAGGCCTACACCCCAGCAACCA |
| RAB2 | NM_002865 | F | AGATAAAACTTCAGATATGGGATACGG |
| | | R | GCTGCACCTCTGTAATACGACC |
| | | P | AGGGCAAGAATCCTTTCGTTCCATCAC |
| NDRG2 | NM_016250 | F | CCCAATGCCAAGGGTTG |
| | | R | TCCGGAATGGAAGAGGTGAG |
| | | P | ATGGATTGGGCAGCCCACAAGCTAA |
| NK4 | M59807 | | ABI # Hs00170403_m1* |
| HIF1α | NM_001530 | F | TTACCATGCCCCAGATTCAG |
| | | R | ATTCACTGGGACTATTAGGCTCAG |
| | | P | AGACACCTAGTCCTTCCGATGGAAGCACT |
| VEGF | NM_003376 | F | TTGGGTGCATTGGAGCC |
| | | R | GGGTGCAGCCTGGGAC |
| | | P | TGCCTTGCTGCTCTACCTCCACCA |
| RPL6 | BC022444 | | ABI # Hs00735484_m1* |
| PCNA | NM_182649 | | ABI # Hs004272214_g1* |

F is forward, R is reverse, P is probe and * represents Assay-on-Demand set (Applied Biosystems; Foster City, CA).

### Results

Assessment of the Quality of Microarray Data. A total of four arrays (two direct replicates and two dye-flip replicates) were analyzed for comparison of RNA from TSC mutant vs. control renal epithelial cells. A total of six arrays (four direct replicates and two dye-flip replicates) were analyzed for comparison of RNA from VHL mutant vs. control renal epithelial cells. The total number of negative controls (blank spots or wells containing 50% DMSO) on the 10 arrays was 8340. Only 1% (99/8340) of these spots were identified as false positives having intensities above the threshold in both channels. None of the false positives were expressed across all of the arrays in either of the two experiments, and thus have been eliminated from all subsequent analyses, as described hereinabove.

The Pearson Correlation coefficients between log₂ ratios from replicate experiments were calculated only for genes expressed in all arrays of each microarray comparison, resulting in six (four arrays, six pairs of comparisons) and 15 (six arrays) coefficients for TSC and VHL, respectively. Correlation coefficients ranged from 0.72 to 0.95 for TSC (for 4720 expressed genes) and 0.72 to 0.96 for VHL (for 5996 expressed genes), resulting in averages of 0.82 and 0.80, respectively, which illustrates good agreement among the replicate experiments.

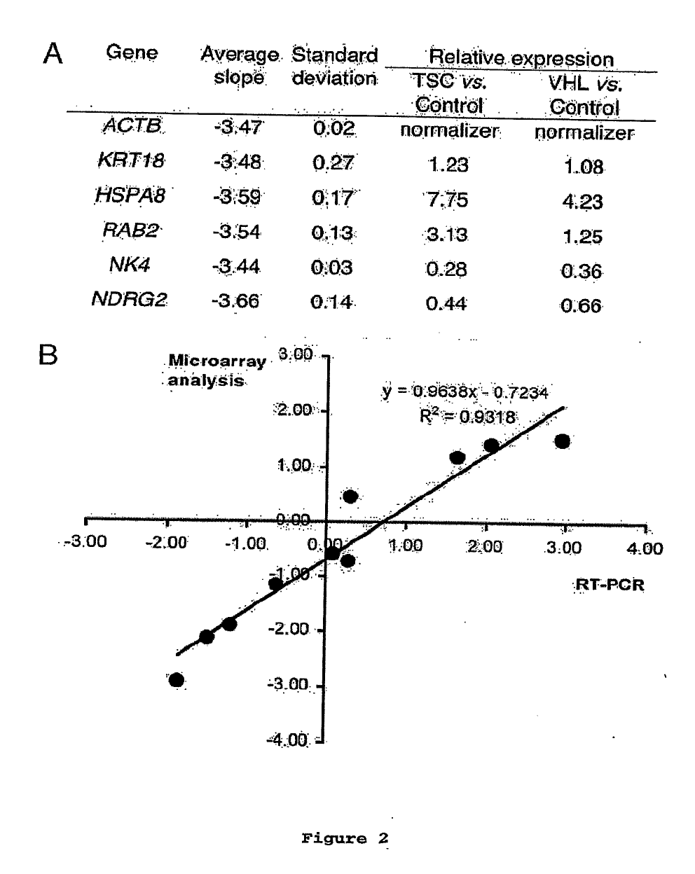

To validate the accuracy of the microarray data, the relative levels of expression of six selected genes in the two syndromes were determined independently by quantitative, real-time fluorogenic Taqman RT-PCR. Genes were selected randomly based on microarray results, indicating that the relative levels of expression of these genes in mutant vs. control renal epithelial cells were upregulated (HSPA8, RAB2), downregulated (NK4, NDRG2) or unchanged (‘house-keeping’ genes, ACTB, KRT18). The Ct values were between 24 and 34 for all PCR reactions (i.e., for all primer sets and template dilutions). The average slopes between the three samples (TSC, VHL and control) of the Ct vs. amounts of initial template plots were between −3.44 and −3.66 with standard deviations between 0.02 and 0.27 (FIG. 2A). When the comparative Ct method of quantifying relative amounts of transcripts was performed using ACTB as the normalizer, the expression of HSPA8 and RAB2 was upregulated and the expression of NK4 and NDRG2 was downregulated in both TSC and VHL (FIG. 2A). The level of expression of KRT18 was not substantially different among the three samples (FIG. 2A). The real-time PCR data were consistent with the microarray data; a high degree of correlation was detected among the expression ratios of the five genes in the TSC and VHL dataset, measured by microarray analysis and RT-PCR (total of 10 data pairs, R²=0.93) (FIG. 2B).

Statistical Analysis. A summary of the statistical analysis of the data is presented in Table 2. Approximately 10-15% of the genes from the genome-wide 40K array are expressed in the two experiments; the number of expressed genes in the VHL experiment is about 30% larger than in the TSC experiment. The average standard deviations for TSC (estimated over four arrays) and VHL (estimated over six arrays) were 0.3399 and 0.248, respectively. Correspondingly, the number of differentially expressed genes (p<0.001) in comparison to controls was smaller in TSC (n=529) than in VHL (n=1905). In both cases, the number of genes with expression significantly different from the normal cells was larger than anticipated based on the false positive rate of the statistical test (0.1%), indicating that there is indeed a bona fide change in the gene expression profiles of the mutant cells relative to the control normal kidney epithelial cells. Further, the low values of statistically significant minimal down- and upregulation show the precision of the data in these experiments (Table 2), with the precision being higher for the VHL experiment. The standard deviations of the log₂ ratios averaged over the replicates were 0.87 and 0.58 for the TSC and VHL datasets, respectively, confirming that the distribution of the ratios in TSC is broader than in VHL.

TABLE 2
Summary of statistical analysis of TSC and VHL microarray data.

| | Mutant Cells | |
|---|---|---|
| | TSC | VHL |
| Replicates (n) | 4 | 6 |
| Expressed genes^{a} (n) | 4720 | 5996 |
| Average standard deviation^{b} | 0.3399 | 0.248 |
| Down-regulated genes^{c (}n) | 225 | 922 |
| Up-regulated genes^{c} (n) | 304 | 983 |
| Minimum signifier negative ratio^{d} | −0.27 | −0.14 |
| Minimum signifier positive ratio^{d} | 0.37 | 0.14 |

| | |
|---|---|
| Genes concurrently downregulated in TSC and | 98 |
| VHL (n) | |
| Genes concurrently upregulated in TSC and | 127 |
| VHL (n) | |
| Genes divergently regulated in TSC and VHL (n) | 380 |

^{a}Genes with intensities above the threshold in both channels in all replicates of an experiment are defined as expressed.
^{b}Estimated as an average of standard deviations across ratios of the expressed genes in all replicates of an experiment.
^{c}Genes differentially expressed in mutant vs. normal cells in a statistically significant manner (p < 0.001).
^{d}Ratios are presented on log₂ scale.

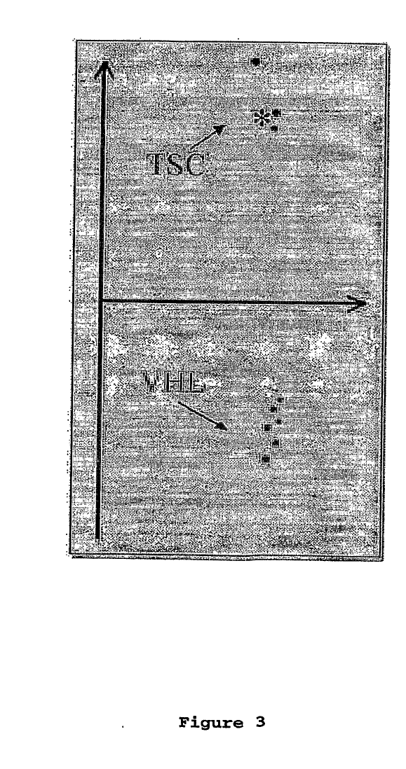

The two-sample t-test, assuming unequal variances between the ratios of TSC vs. normal and VHL vs. normal, was applied to all of the genes that were concurrently expressed in the 10 arrays. A total of 380 genes were divergently expressed (p<0.001) in TSC and VHL mutation carriers. In order to visualize the differences between the TSC and VHL genomic expression profiles relative to the experimental error, defined as the error between replicates, the 10 genome-wide arrays were placed in a Principal Component space, where each point represents an individual array. FIG. 3 demonstrates that the experimental error, indicated by the distance between the replicates, is smaller than the variation that exists between the two syndromes.

Biological Correlates. Several of the genes modulated in heterozygous TSC cells reflect pathways previously implicated in TSC pathogenesis. A critical function of the TSC1-TSC2 complex is to negatively regulate signaling by the protein kinase mTOR, the mammalian target of rapamycin and a critical modulator of translation, cell growth and proliferation. Tuberin displays GTPase-activating protein (GAP) activity towards the Ras family small GTPase Rheb, maintaining it in its GDP-bound state. When tuberin is inhibited by upstream signaling, such as phosphorylation by AKT, increased levels of GTP-bound Rheb result in the activation of mTOR (Bellacosa et AL. (2004) Cancer Biol Ther., 3:268-75; Li et al. (2004) Trends Biochem. Sci., 29:32-8). mTOR phosphorylates targets that have an impact on translation: p70 ribosomal protein S6 kinase (p70 S6K) and eukaryotic initiation factor 4E binding proteins 1, 2 and 3 (4E-BPs) (see Kim et al. (2004) Curr. Top. Microbiol. Immunol., 279:259-70; Gingras et al. (1997) Virology, 237:182-6; Long et al. (2004) Curr. Top. Microbiol. Immunol., 279:115-38; Martin et al. (2002) Adv. Cancer Res., 86:1-39; Proud et al. (2004) Curr. Top. Microbiol. Immunol., 279:215-44). p70 S6K phosphorylates the ribosomal protein S6, which results in increased translation of mRNAs containing 5′-terminal oligopolypyrirnidine (5′TOP) tracts, including ribosomal proteins and other proteins involved in ribosome biogenesis. On the other hand, phosphorylation of 4E-BPs relieves inhibition of the initiation factor eIF4E, which results in more efficient cap-dependent translation (Gingras et al. (1997) Virology, 237:182-6; Ruggero et al. (2003) Nat. Rev. Cancer, 3:179-92). Ribosomal protein genes are represented on the 40K array by 101 spots, corresponding to single or multiple clones of 69 unique ribosomal protein genes. Fifty out of the 101 spots contained signals expressed in all TSC and VHL arrays. Upregulated genes, especially in the TSC dataset, dominated the expression profile of the ribosomal protein genes, not only in terms of the number of overexpressed genes, but also in terms of the magnitude of overexpression relative to control cells (FIG. 4). Interestingly, four of these genes (L6, L21, S6, S25) are human orthologs of yeast ribosomal protein genes known to be transcriptionally downregulated de facto by rapamycin (Cardenas et al. (1999) Genes Dev., 13:3271-9; Powers et al. (1999) Mol. Biol. Cell, 10:987-1000). This suggests that, similar to yeast, some ribosomal protein genes may be regulated at the transcriptional level via TSC/mTOR in mammalian cells.

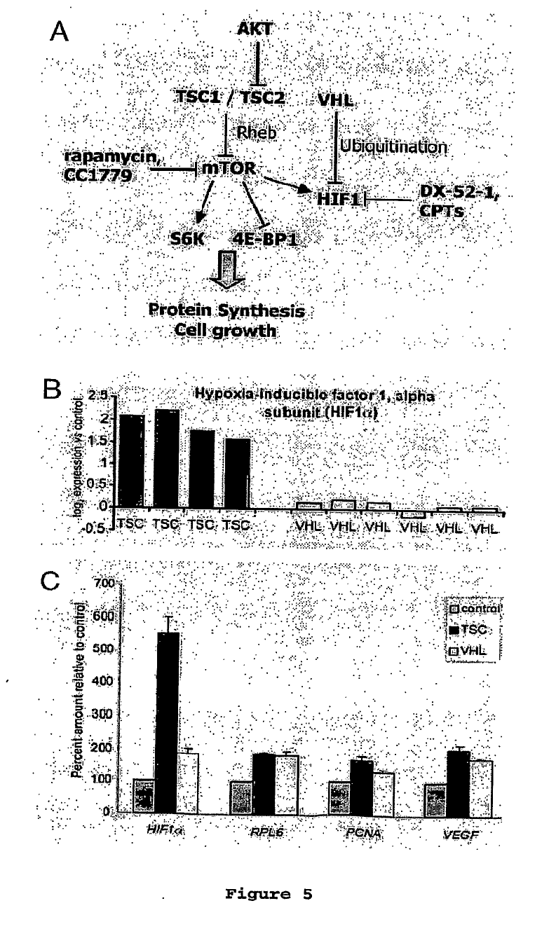

The HIF1 transcription factor is overexpressed in kidney cancer associated with either VHL or TSC mutations, suggesting that a normal function of VHL and TSC1-TSC2 is to suppress HIF1 expression (Linehan et al. (2003) J. Urol., 170:2163-72; Kim et al. (2003) Curr. Opin. Genet. Dev., 13:55-60). While VHL is known to suppress HIF1 at the posttranscriptional level, by promoting the ubiquitination and degradation of its α subunit, recent publications indicate that tuberin regulates, in part, the α subunit of HIF1 at the transcriptional level (FIG. 5A) (Linehan et al. (2003) J. Urol., 170:2163-72; Kim et al. (2003) Curr. Opin. Genet. Dev., 13:55-60; Brugarolas et al. (2003) Cancer Cell, 4:147-58; Liu et al. (2003) Cancer Res., 63:2675-80). Consistent with these findings, HIF1α subunit mRNA was upregulated significantly in heterozygous TSC cells and only marginally upregulated in heterozygous VHL renal epithelial cells (FIG. 5B). Furthermore, several of the genes modulated in heterozygous VHL cells confirmed results obtained by comparing homozygous mutant VHL renal carcinoma lines before and after reconstitution with wild-type VHL cDNA (Zatyka et al. (2002) Cancer Res., 62:3803-11). Specifically, of the nine genes identified as VHL targets in this study, five mRNAs (for collagen type VIIIα1, interleukin 6, low-density lipoprotein-related protein 1, VEGF and CD59) were upregulated in heterozygous VHL cell strains.

Due to the detection of changes in the expression of the HIF1α mRNA, other genes involved in the cellular response to hypoxia were evaluated. Interestingly, the mRNAs for hypoxia-inducible protein 2 and for hypoxia-induced gene 1 showed an expression profile similar to HIF1α (upregulated 2- and 5-fold, respectively, in TSC mutant cells, and unchanged in VHL mutant cells as compared to nonmutated controls). In contrast, the level of transcripts for the HIF1α (inhibitor was unchanged in TSC mutant cells and upregulated 2-fold in VHL mutant cells. No change in the mRNA for HIF prolyl 4-hydroxylase was detected in either TSC or VHL mutant cells.

The expression of genes known to be involved in cell cycle regulation was also examined. Among these, the mRNA for the S-phase marker, PCNA, was upregulated 3-fold in both VHL and TSC mutant cells.

In order to validate the findings obtained by microarray analysis, real-time RT-PCR assays were conducted on some of the relevant genes that had emerged as significantly upregulated in mutant TSC or VHL cells. This analysis was conducted on pools of total RNA from TSC, VHL or control renal epithelial cultures. Relative quantification of each transcript in the TSC and VHL pools was performed using a standard curve generated with serial dilutions of the control pool. The results shown in FIG. 5C largely confirmed the microarray data. In particular, the level of HIF1α mRNA was increased several fold in TSC cells but only minimally in VHL cells. In parallel, the HIF1αtranscriptional target VEGF was concomitantly upregulated, albeit to a lesser extent, in mutant cells, with relatively higher levels in TSC cells than in VHL cells. PCNA mRNA was also upregulated (3-fold), suggesting a potential, subtle alteration of the cell cycle in VHL and TSC cells.

Finally, cluster analysis of the genes most divergently expressed between the TSC and VHL datasets revealed transcripts for cytoskeletal, membrane-associated and extracellular matrix proteins (FIG. 6), suggesting that heterozygous TSC and VHL cells may differ significantly in their cell-extracellular matrix binding profiles.

### Example II

### The Methods Provided Below can be Used to Facilitate the Practice of the Following Examples

### Subject Accrual

Eligible cases included men and women who had been diagnosed previously with one of the following heritable syndromes and corresponding gene mutations: familial adenomatous polyposis (APC), hereditary nonpolyposis colon cancer (MLH1), hereditary breast cancer (BRCA1 and 2), hereditary ovarian cancer (BRCA1 and 2), tuberous sclerosis (TSC) and von Hippel-Lindau syndrome (VHL). For each syndrome a minimum of six affected persons and six healthy controls were accrued. Individuals with a personal history of cancer were ineligible, except in the case of renal disorders where nonneoplastic tissue was otherwise unavailable. Subjects treated previously with either chemotherapy or radiation were ineligible.

All subjects were recruited with the approval of the FCCC Institutional Review Board, irrespective of gender, race and age. TSC mutation carriers were accrued from various hospitals in the U.S. VHL mutation carriers were enrolled in the study by NCI. Phenotypically normal appearing renal tissue was collected from sporadic renal cancer patients (nonmutation carriers) undergoing nephrectomy at FCCC. Nonneoplastic breast and ovarian tissue was obtained from BRCA1 and 2 mutation carriers who were enrolled on the study at various institutions throughout the U.S. Breast and ovarian tissues were obtained from nonmutation carriers undergoing prophylactic oophorectomy or mastectomy or breast reduction surgery at FCCC and various other institutions. Mutation carriers with dominantly heritable colon syndromes were identified at institutions throughout the country. Over 70% of the tissue samples were collected from the surgical specimens by an experienced pathologist within the Chemoprevention Program at FCCC. Biopsies of nonneoplastic colon tissue were obtained from individuals undergoing routine colonoscopy in the Endoscopy Clinic at FCCC.

Blood samples for lymphocyte analysis were transported to the Cell Culture Facility at FCCC at room temperature within 24 hours of collection. Tissue samples (colon and skin) from which cell strains were to be derived were transported to the Cell Culture Facility at FCCC in transport media and on ice. Colon tissues frozen in OCT were transported to FCCC on dry ice. All specimens from outside institutions were either hand-delivered to FCCC or shipped by Fed Ex for overnight delivery.

### Cell Culture

The specific protocols for establishing primary cell strains from each target organ are summarized below.

Normal renal tissue was collected from renal cancer patients from a site distal to the renal tumor. Upon arrival in the lab in transport media, renal tissue was finely minced using two scalpels under sterile conditions. The minced tissue was digested using 0.2% collagenase in a 15 ml tube, gently rotating in a 37° C. water bath, for 1 hour. The tissue was then rinsed five times with F-12 media and transferred to a flask containing ACL-4 media plus 0.5% FBS supplemented according to previously established protocols. The cultures of renal epithelial cells took three to six weeks to establish and were passaged at confluency.

Prophylactic oophoretomy specimens were collected under aseptic conditions D and placed in transport medium (M199:MCDB105 (1:1), penicillin, streptomycin, glutamine). Upon arrival in the laboratory, the ovaries were processed to establish epithelial cell and fibroblast cultures. Epithelial cell cultures were established by immersing the intact ovary in transport medium and gently scraping the ovarian surface with a rubber policeman. The medium containing cells was then centrifuged, aspirated, and the cell pellet was resuspended in fresh medium (M199:MCDB105 (1:1), 5% FBS, penicillin, streptomycin, glutamine and 0.3 U/ml insulin). Cells were then transferred to tissue culture flasks coated with swine skin gelatin. The cells were refed every four days and passaged once they reached confluency. Fibroblast cultures were established by mincing ovarian tissue, excluding the cell surface layer, into 1 mm² pieces using sterile scalpels. The pieces were resuspended in DMEM medium containing 20% FBS, penicillin, and streptomycin and transferred to tissue culture flasks coated with both swine skin gelatin and fetal bovine serum. The cells were refed every four days and passaged once they reached confluency.

Surgical breast specimens were transported to the lab in transport media. Left and right breast tissues were treated separately. The tissue was finely minced and placed in a 50 ml tube in 200 U/ml solution of collagenase containing hyaluronidase, hydrocortisone, insulin and 10% horse serum in a DMEM/Media 199 base. The tissue was digested overnight in a 37° C. water bath with gentle shaking. The tissue was then washed five times. A small portion of the tissue was set aside for fibroblasts. The majority of the tissue was transferred to a swine skin gelatin-coated flask containing High Calcium Media. After 24 hours, the tissue was transferred to media supplemented with 0.04 mM calcium, 5% chelated horse serum, epidermal growth factor, cholera toxin, insulin and hydrocortisone (Low Calcium Media). Cells were cultured four to six weeks until the flask was confluent. A small amount of tissue, as described above, was used to set up fibroblast cultures. The cells were transferred to a small swine skin gelatin and FBS-coated flask containing fibroblast media, DMEM+15% FBS plus supplements. It usually took two to four weeks for fibroblasts to grow out.

Colon biopsies and surgical specimens were transported to the laboratory in transport media and treated with collagenase to disperse the colonic crypts. The resulting samples were cultured under three separate media conditions. For preferential growth of epithelial cells, the culture media (DMEM) was supplemented with 1% FBS, transferrin, insulin, glucose, epidermal growth factor and hydrocortisone. Growth of colonic fibroblasts was targeted by culturing the cells in high serum (DMEM plus 15% PBS) containing L-glutamine and sodium pyruvate. Lastly, an alternative method, which enriched for epithelial cell growth, employed Low Calcium Media as defined above.

A lymphocyte culture protocol, which yields cell populations consisting of greater than 90% pure T cells, was established. Briefly, white cells were isolated from whole blood by centrifugation over Histopaque. The resulting cells were incubated on swine gelatin-coated flasks to remove adherent (monocyte) cell populations. Following three days of culture in PHA-M, the cells were transferred to media (RPMI 1640 and 10% FBS supplemented with insulin, penicillin/streptomycin, and gentamycin) without PHA-M and prepared for drug treatment.

### RNA Extraction

Total RNA was prepared from cultured cells by extraction in guanidinium isothiocyanate-based buffer containing P-mercaptoethanol and acid phenol (Chomczynski, P. and Sacchi, N. (1987) Anal. Biochem. 162:156-159). RNA integrity was evaluated by formaldehyde-agarose gel electrophoresis and A260/A280 ratios.

### RNA Amplification

For RNA amplification for the FCCC cDNA microarray platform, a modification of Eberwine's protocol (van Gelder et al. (1990) Proc. Natl. Acad. Sci., 87:1663-1667; Baugh et al. (2001) Nucleic Acids Res., 29:E29) was used, as described previously (Stoyanova et al. (2004) J. Cell. Physiol., 201:359-365). Briefly, double-stranded cDNA (ds-cDNA) was synthesized from each of the pooled total RNAs (200 ng/sample×six samples) using the Superscript Double-Stranded cDNA Synthesis Custom Kit (Invitrogen, Carlsbad, Calif.) and an oligo-(dT)₂₄-T7 primer (5′-AAACGACGGCCAGTGAATTGTAATACG-ACTCACTATAGGCGC-(dT)₂₄-3′). The ds-cDNA was extracted once each with phenol/chloroform and chloroform and purified with Microcon YM-100 spin columns (Millipore, Bedford, Mass.) prior to amplification by T7 RNA polymerase.

The Ampliscribe T7 transcription kit (Epicentre Technologies, Madison, Wis.) was used for one round of RNA in vitro transcription by T7 RNA polymerase. The resulting amplified, complementary RNA (aRNA) was extracted and washed using Microcon YM-100 spin columns.

For the Affymetrix GeneChip platform, amplification of total RNA was accomplished using the Ovation™ Biotin system kit (NuGen Technologies, Inc., San Carlos, Calif.). This kit is based on the Ribo-SPIA technology, a rapid RNA amplification process that combines fragmentation and direct chemical attachment of biotin to amplified cDNA. Following this protocol, 50 ng of total RNA was utilized for the generation of first-strand cDNA using reverse transcriptase and a unique first-strand DNA/RNA chimeric primer. The primer has a portion of DNA that hybridizes to the mRNA poly(A) sequence. The resulting cDNA/mRNA hybrid molecule contains a unique RNA sequence at the 5′ end of the cDNA strand. Fragmentation of the mRNA within the cDNA/mRNA complex creates priming sites for a proprietary DNA polymerase to synthesize a second strand, which includes DNA complementary to the 5′ unique sequence from the first-strand chimeric primer. The result is a double-stranded cDNA with a unique DNA/RNA heteroduplex at one end.

The SPIA amplification uses a DNA/RNA chimeric primer, DNA polymerase and RNase H in a subsequent homogeneous and isothermal assay that provides highly efficient amplification of DNA sequences. RNase H is used to degrade RNA in the heteroduplex, resulting in the exposure of a DNA sequence that is available for binding a second SPIA chimeric primer. DNA polymerase then initiates replication at the 3′ end of the primer. The RNA portion at the 5′ end of the newly synthesized strand is again removed by RNase H so that a next round of cDNA synthesis can be initiated. This process is repeated multiple times, resulting in rapid accumulation of cDNA complementary to the original mRNA. The resulting amplified single-stranded cDNA product generated by amplification is the antisense of the starting RNA and is, therefore, compatible with the probe design of the Affymetrix GeneChip platform. Using this technology, microgram quantities (4-6 μg) of amplified cDNA can be generated from 50 ng of starting total RNA.

### Microarray Analyses

For the FCCC cDNA microarray platform, amplified RNAs were used to synthesize cDNA probes labeled by indirect (amino-allyl) incorporation of Cy3 and Cy5, as described previously (Stoyanova et al. (2004) J. Cell. Physiol., 201:359-365). Probes were prepared for two pairs of replicates, including dye-flips. For each of the six reactions (two for TSC, two for VHL, and two for controls), 4 μg of aRNA, 10U of random hexamers, and 400 U of Superscript II (200 U/ml; Invitrogen) were used (Stoyanova et al. (2004) J. Cell. Physiol., 201:359-365). After alkaline hydrolysis of residual RNA, the cDNA probes were ethanol-precipitated overnight at −20° C. The next day, the reactions were centrifuged at 14,000×g for 30 min. at 4° C. The supernatant was removed, and the pellets were washed with 70% ice-cold ethanol and air-dried.

The cDNA pellets were resuspended in 15 μl of IX coupling buffer (0.2 M NaHCO₃, pH 9.0) and divided into two 7.5 μl aliquots. Each aliquot was mixed with 2.5 μl of prepared Cy3 or Cy5, respectively, and incubated at room temperature in the dark for 1 hour. Forty microliters of 100 mM NaOAc, pH 5.2, was added to each reaction, and the labeled probes were purified using the QIAquick PCR purification kit (Qiagen, Inc., Valencia, Calif.) as described previously (Stoyanova et al. (2004) J. Cell. Physiol., 201:359-365).

The concentration of the Cy3- or Cy5-labeled cDNA probes was determined in an ND-1000 Spectrophotometer (NanoDrop Technologies, Inc., Montchanin, Del.). Eighty picomoles of each probe were mixed with 10 μg of poly-A DNA and 10 μg of human Cot I DNA (Invitrogen) and dried in a vacuum centrifuge. The resulting pellets were resuspended in 25 μl of 1× hybridization buffer (50% formamide, 5×SSC, 0.1% SDS) and divided into two 12.5 μl aliquots. Each dye-labeled aliquot, corresponding to 40 picomoles, was then mixed with 12.5 μl of the opposite dye-labeled aliquot from the opposing genotype and heated at 100° C. for 3 minutes prior to hybridization with human 40,000 (40K) cDNA microarrays.

Approximately 40,000 human cDNA clones (40K set, Research Genetics, Huntsville, Ala.) were PCR-amplified, with product generation confirmed by agarose gel electrophoresis. The clones were printed onto three polylysine-coated slides, two with 15,552 and one with 10,368 spots, in the DNA Microarray Facility of the FCCC. Hybridization was performed in a 42° C. water bath for 16-20 hours under a glass cover slip (Corning, Acton, Mass.) in ArrayIT hybridization cassettes (TeleChem International, Inc., Sunnyvale, Calif.). After hybridization, the slides were washed twice (10 minutes each) at room temperature in pre-heated (55° C.) 1×SSC, 0.2% SDS and pre-heated (55° C.) 0.1×SSC, 0.2% SDS, followed by 0.1×SSC (1 minute) and dH₂O (10 seconds). Slides were fast-dried by centrifugation in a swinging bucket rotor at 650 rpm for 5 minutes in an Eppendorf MDL5810R centrifuge.

The slides were scanned with a GMS 428 Scanner (Affymetrix, Santa Clara, Calif.) at select laser intensity and photomultiplier tube voltage parameters, which allowed the analysis of each slide over a full dynamic range in the respective channel. Image segmentation and spot quantification were performed with the ImaGene software (BioDiscovery, Marina del Rey, Calif.).

For the Affymetrix GeneChip platform, amplified cDNAs were fragmented and biotin-labeled, according to NuGen's recommendations. cDNA concentration was measured before and after fragmentation using a NanoDrop spectrophotometer. In order to determine the size distribution of the amplified cDNA and confirm successful fragmentation, every amplified cDNA sample (before and after fragmentation) was evaluated on a capillary electrophoretic system (Bioanalyzer, Agilent), using the nano chip and the mRNA software. Fragmented and biotin-labeled cDNAs were then hybridized onto Affymetrix human U133 plus 2.0 GeneChip arrays. GeneChip arrays were prehybridized with hybridization buffer at 45° C. for 10 minutes in an Affymetrix rotating incubator (60 rom). Hybridization was performed using a hybridization cocktail containing hybridization buffer, 2.2 μg of each fragmented biotin-labeled cDNA sample, bovine serum albumin (BSA), herring sperm DNA, Affymetrix hybridization controls 20× and B2, and DMSO. Hybridization was conducted at 45° C. overnight (18 hours) at 60 rpm. After the overnight incubation, hybridization cocktails were removed and the GeneChip arrays were stored at −20° C. The arrays were then washed and stained according to the EukGE-WS2v4 protocol using the Affymetrix GeneChip Fluidics station 450. The wash consisted of nonstringent Wash Solution A and stringent Wash Solution B, prepared according to Affymetrix. Staining of the GeneChip arrays was conducted in the Fluidics station using the SAPE stain solution (containing stain buffer, BSA, streptavidin-phyocoerythrin and water), and the antibody solution (containing stain buffer, BSA, goat IgG stock, biotinylated antibody and water). After the wash-stain was completed, arrays were scanned with the Affymetrix GeneChip scanner 3000 to acquire data.

### Statistical Analyses

For the FCCC cDNA microarray platform, the initial statistical analysis of expression data from TSC and VHL cases addressed the question of whether there are genes that are differentially expressed in mutant cells as compared to nonmutated control cells. For each gene, the null hypothesis, that the mean ratios of the data are 1 (on log, scale, 0), was tested using a two-sided, one-sample t-test. The t-statistic was calculated for genes with non-zero values in all arrays for each syndrome. Genes differentially expressed in the mutant cells vs. the normal controls (p<0.001) for each syndrome were separated into two groups: up- or downregulated in either TSC or VHL, and also concurrently up- and downregulated in both TSC and VHL relative to normal cells. The identity and function of the genes in these lists were examined by querying the SOURCE database (Diehn et al. (2003) Nucleic Acids Res., 31:219-23). The log, values of the expression ratios of genes concurrently expressed in all replicates were averaged and the histograms of their distributions characterized.

Principal Component Analysis (PCA) was applied to assess the overall differences between samples and their replicates. PCA is an invaluable aid in the exploration of large genomic datasets, allowing representation of complex data in lower dimensional space, defined by the Principal Components (PCs) (Misra et al. (2002) Genome Res., 12:1112-20). PCA was applied to a data matrix containing the gene expression ratios across all replicate and dye-flip experiments. Thus, each array is represented as a point in a coordinate system, defined by the PCs. The distance between replicate samples reflects the experimental error. The method has been used previously in the analysis of microarray data from time-course experiments (Alter et al. (2000) Proc. Natl. Acad. Sci., 97:10101-10106; Alter et al. (2003) Proc. Natl. Acad. Sci., 100:3351-3356), normalization of gene expression ratios obtained from two different microchips of two-channel arrays (Nielsen et al. (2002) Lancet 359:1301-1307), and for partitioning large-sample microarray-based gene expression profiles (Peterson, L. E. (2003) Comput. Methods Programs Biomed., 70:107-119).

To identify clusters of genes simultaneously up- and downregulated in TSC and VHL samples, Hierarchical Cluster Analysis (HCA), as described above, was applied to the data matrix described above.

For the Affymetrix GeneChip platform, the false discovery rate can be estimated as follows. A class comparison yields a p-value for each gene, which measures its statistical significance. Given a set of p-values, the q-value method estimates the portion of false positives among the genes found to be significant; i.e., the proportion of statistically significant genes that are truly expressed. For each gene, a measure of significance in terms of false discovery rate (FDR), called the q-value (corresponding to each p-value), was calculated. The q-value for a given gene is the minimum FDR incurred when calling that gene significant. It is a measure of quality of genes in a gene list and of more extreme genes, and, hence, aids us in making informed decisions.

Unlike a standard approach such as analysis of variance (ANOVA), which is applied to the data on a gene-by-gene basis, local pooled error (LPE) attempts to reduce dependence on the within-gene estimates for variability by pooling variance estimates within regions of similar gene expression, i.e., by borrowing strength across genes with similar expression. Due to the large number of genes, there will be genes that have low or high within-gene variance estimates due to chance, resulting in extreme values of signal-to-noise ratios regardless of mean expression intensities and fold changes. This pooled estimate of variability was then used in calculating the statistical significance (p-value). The p-values were further adjusted to control the FDR using the q-value method described above.

Unsupervised clustering methods such as nonnegative matrix factorization (Brunet et al. (2004) Proc. Natl. Acad. Sci., 101:4164-4169; Devarajan, K. and Ebrahimi, N. (2005)), PCA and hierarchical clustering were applied to explore the data and identify potential subgroups of samples and genes of interest.

### Example III

### Preparation of Samples for Microarray Analysis

Epithelial cell strains were established from the renal tissue of six TSC patients, eight VHL patients, and six controls. High-quality RNA was isolated from control (untreated and vehicle (0.01% DMSO)) and drug-treated (sulindac, tamoxifen and genistein) cultures and banked for future analysis on an individual basis. A set is composed of the following treatment conditions: untreated, 0.01% DMSO, sulindac, tamoxifen and genistein. Six normal sets, 6 TSC sets and 6 VHL sets of RNA samples isolated from primary renal epithelial cell strains were isolated, banked, and available for microarray analysis

In order to ensure that the primary renal cultures exhibited normal chromosomal integrity, three of the six control cell strains from nonmutation carriers were subjected to karyotypic analysis. Two of the cell strains exhibited a normal karyotype, while the third had a mosaic karyotype with trisomies detected for chromosomes 7 and 10. Trisomies for chromosomes 7 and 10 have been reported in nonneoplastic kidney cells and these aberrations are not considered to be cancer-associated changes.

Renal tissue from three individuals with hereditary papillary renal carcinoma (HPRC) was obtained. Genome-wide arrays were completed on epithelial cell strains derived from two of these patients using the FCCC cDNA microarray platform.

Genome-wide arrays were performed on the FCCC cDNA microarray platform initially using pools of amplified RNA from mutation carriers (TSC and VHL) and controls. Analyses were completed on sets of renal epithelial cell RNA from six subjects per genotype (wild-type, TSC and VHL) using the Affymetrix GeneChip platform.

The collection, establishment, and drug treatment of cultures of ovarian surface epithelial cells and fibroblasts (wild-type and BRCA1 and BRCA2 mutation carriers) were completed. High-quality RNA was isolated from control (untreated and vehicle (0.01% DMSO)) and drug-treated (sulindac, tamoxifen and 4-HPR) cultures and banked for future analysis on an individual basis. A set is composed of RNA isolated from one untreated, two DMSO-treated, one 4-HPR-treated, one tamoxifen-treated, and one sulindac-treated culture of primary cells. The number of sets of ovarian RNA samples that were available for microarray analysis is summarized as follows: epithelial—8 BRCA1, 8 BRCA2, and 13 control and fibroblast—13 BRCA1, 11 BRCA2, and 13 control. Although some of these cultures were derived from the left and right ovaries of the same individual, RNA has been stored for analysis from at least six independent subjects per genotype. Analyses have been completed on sets of ovarian epithelial cell RNA from six subjects per genotype (wild-type, BRCA1 and BRCA2) using the Affymetrix GeneChip platform.

The collection, establishment and treatment of all of the breast epithelial and fibroblast cultures (control, BRCA1, BRCA2) were completed. High-quality RNA was isolated from control (untreated and vehicle (0.01% DMSO)) and drug-treated (sulindac, tamoxifen and 4-HPR) cultures and banked for future analysis on an individual basis. A set is composed of RNA isolated from one untreated, two DMSO-treated, one 4-HPR-treated, one tamoxifen-treated, and one sulindac-treated culture of primary cells. The total number of sets of breast RNA samples that were available for microarray analysis is summarized as follows: epithelial 8 BRCA1, 10 BRCA2, and 8 control and fibroblasts—12 BRCA1, 14 BRCA2, and 26 control. As for ovary, while some of these cultures were derived from the left and right breast of the same individual, RNA was stored for analysis from at least six independent subjects per genotype. Analyses were completed on sets of breast epithelial cell RNA from six subjects per genotype (wild-type, BRCA1 and BRCA2) using the Affymetrix GeneChip platform.

A summary of the FAP, HNPCC and control cases that were accrued by FCCC is presented in Table 3. Primary cell cultures have been or are presently being banked from all specimens of colonic mucosa and skin.

TABLE 3
Control, FAP, and HNPCC Cases.

| | | | Cancer Free |
|---|---|---|---|
| | FAP | MLH1 | Control |
| Enrolled Subjects | 26* | 16* | 12\hat{ } |
| Males | 11 | 9 | 5 |
| Females | 15 | 7 | 6 |
| Mean Age (years) | 27.8 | 43.3 | 56.2# |

*confirmed mutation carriers;
\hat{ }one subject of unknown gender;
#one subject of unknown age.

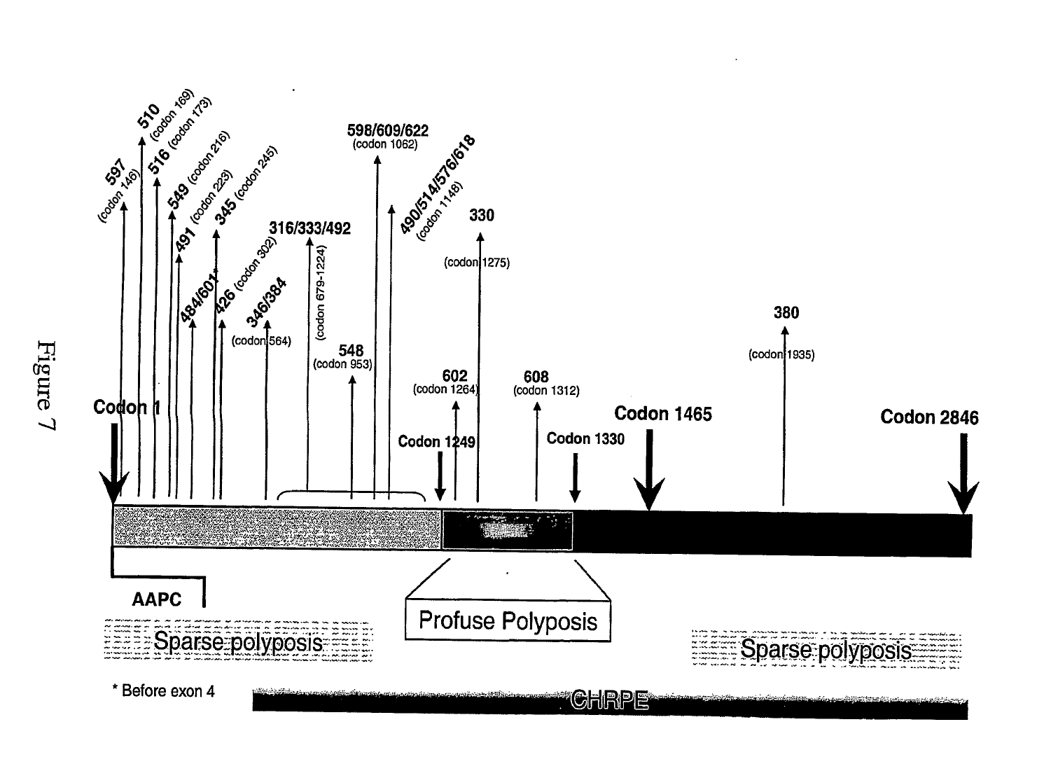

With regard to the FAP cases, only three individuals have been identified who carry a mutation within the mutation cluster region of APC (FIG. 7). Eighty-eight percent of the FAP cases enrolled to date have APC mutations that are 5′ to the mutation cluster region. In addition, no correlation has been observed between the location of the mutation and phenotype severity. For this reason, all specimens were evaluated by microarray on an individual basis.

Cultures established under the low serum and high serum conditions routinely resulted in robust growth of cells with primarily fibroblast-like characteristics. On the other hand, low calcium conditions supported the growth of cells with strong epithelial characteristics, but such lines were established rarely, and to date have arisen only from patients with polyposis.

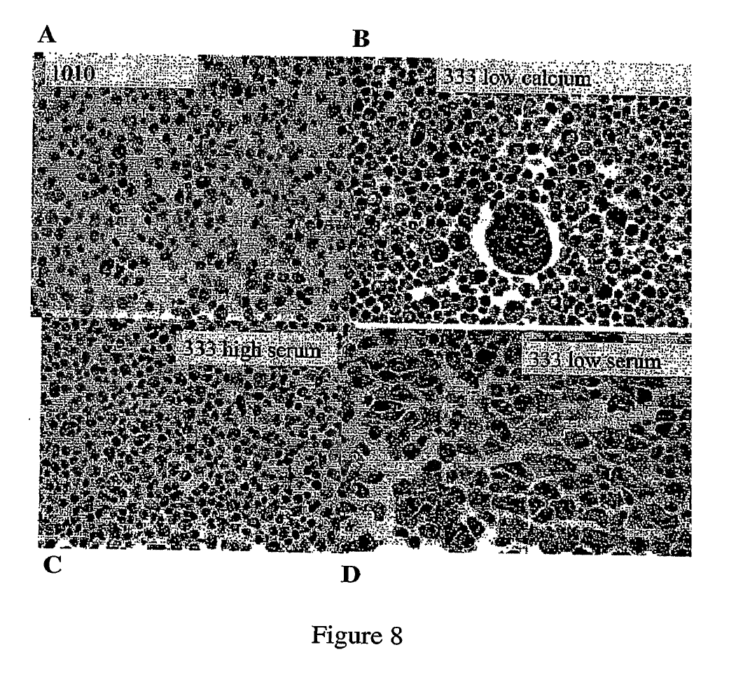

The fibroblast and epithelial characteristics of colonic cells grown under each culture condition were examined using a panel of informative antibodies. The morphological features of a representative culture are presented in FIG. 8. Notably, mucin vacuoles and a cluster of cells formed a gland-like structure in culture grown in low calcium ((FIG. 8B). Four cell strains, which exhibit an immunoreactivity profile indicative of epithelial cells, have been established in media containing 0.04 mM calcium (Table 4). It should be noted that no APC mutation was detected by Myriad in case 347, which exhibited a polyposis phenotype (>50 polyps).

TABLE 4
Summary of the immunohistochemical staining profile of
colonic epithelial cells grown in media containing 0.04 mM calcium.

| | Subject ID | | | |
|---|---|---|---|---|
| | 333 | 548 | 426 | 347 |
| APC mutation | codon 1072 | codon 953 | codon | undetected |
| | | | 302 | |
| Mucin in vacuoles | + | + | + | + |
| Vimentin | <1 | 10 | − | 85 (weak) |
| CK 20 (cytokeratin) | 100 | 100 | 80 | 15 |
| CAM 5.2 (cytokertain) | 100 | 100 | 100 | 100 |
| AE1/AE3 (cytokeratin) | 100 | 100 | 80 | 100 |
| E-cadherin | 100 | + | + | + |
| CEA | 100 | 100 | 100 | 100 |
| HHF35 (muscle actin) | 5 | − | − | <10 |
| β-catenin | M/C/N | C/N | M | M (some)/C |

Numbers are percentage of immunoreactive cells.
M—membrane;
C—cytoplasmic;
N—nuclear.

In order to determine if a second hit had occurred in vitro, conferring a growth advantage, colonic epithelial cells were examined for loss of heterozygosity (LOH) of APC. Full sequence analysis of sample 333 by Myriad (cells cultured in media containing 0.04 mM calcium) revealed that additional mutations in the APC gene had been acquired during culture (Table 5). Cells derived from subject 426, and cultured under similar conditions, have acquired a 5′ rearrangement, as determined by Southern blot, in addition to the germline mutation at codon 302. These data suggest that a second hit in the APC gene is required for growth in culture, a conclusion consistent with the inability of cells from nonmutation carriers (bearing wild-type APC) to grow in culture.

TABLE 5
Characteristics of colonic epithelial cells grown in media
containing 0.04 mM Calcium. The epithelial type confirmed using
the eight immunohistochemical markers listed in Table 4.

| | | | LOH of | Growth in Soft Agar |
|---|---|---|---|---|
| SID | Blood | Cultured Cells | APC | or Methylcellulose |
| 333 | codon | 3 mutations, | not tested | negative |
| | 1072 | 2 deleterious and | | |
| | | 1 of unknown | | |
| | | significance | | |
| 426 | codon 302 | codon 302 and 5′ | negative | negative |
| | | rearrangement | | |
| 548 | codon 953 | not tested | not tested | negative |
| 347 | undetected | not tested | not tested | negative |

For most patients, multiple samples were extracted from different portions of the colon (i.e., left and right colon), and these were cultured separately to control for any inherent alterations in gene expression that may exist between the different colonic environments. Notably, all strains of colonic epithelial cells that grew in media containing 0.04 mM calcium were generated from tissues derived from the left (not right) colon. Once the cells were grown to adequate numbers, they were harvested and either sent for drug testing or banked. A total of 362 individual colonic cell strains have been processed.

Table 6 summarizes the number of cell strains that have been drug-treated to date. High-quality RNA has been isolated from each cell strain, quantified and banked for future analysis.

TABLE 6
Established cell strains that have been subjected to drug treatment. Five
samples have been banked for each cell strain: untreated, 0.1% DMSO,
sulindac, tamoxifen and celecoxib.

| | Subjects | 1% | 15% | Low | | |
|---|---|---|---|---|---|---|
| Syndrome | (n) | FBS | FBS | Calcium | Lymphocytes | Skin |
| Normal | 10 | 4 | 14 | 0 | 0 | 0 |
| HNPCC | 16 | 12 | 16 | 0 | 14 | 0 |
| FAP | 30 | 24 | 27 | 3 | 21 | 20 |

In order to decrease the time and effort associated with treating colonic epithelial cells and fibroblasts with chemopreventive agent, the remaining primary cell strains were banked and treated with chemopreventive agent at the time of selection of specific cases for array-based analysis. Table 7 summarizes the number of colonic cell strains listed above that were expanded and banked for future drug testing.

TABLE 7
Colonic cell strains banked in liquid nitrogen prior to drug treatment.

| Syndrome | Subjects (n) | 1% FBS | 15% FBS |
|---|---|---|---|
| Normal | 8 | 11 | 6 |
| HNPCC | 6 | 1 | 10 |
| FAP | 15 | 28 | 28 |

Specimens of colonic tissue were collected from FAP cases (at the time of colectomy) and healthy controls (during routine colonoscopy) and frozen in OCT embedding compound (Table 8). Additional FAP cases have been accrued by Thomas Jefferson University (TJU).

TABLE 8
Control and FAP cases accrued by FCCC.

| | FAP | Control Without Cancer |
|---|---|---|
| Confirmed Mutation Carriers | 24 | 24 |
| Males | 10 | 9 |
| Females | 14 | 15 |
| Mean age (years) | 31.7 | 57.8 |

Lymphocytes were obtained from eight VHL mutation carriers and three subjects with HPRC. Cultures were established successfully from all samples and treated with chemopreventive agents (DMSO, tamoxifen, sulindac and genistein). High-quality RNA was isolated from all cultures and banked for future analysis.

Lymphocytes were collected, established, and treated from six controls, six BRCA1 mutation carriers, and four BRCA2 mutation carriers. Lymphocytes from all patients from whom breast and ovarian tissue were collected were treated with DMSO, tamoxifen, sulindac and 4-HPR.

Lymphocyte cultures were established for a total of 35 patients (14 HNPCC and 21 FAP) from whom colon tissue was obtained. High-quality RNA was isolated from cultures treated with vehicle (DMSO), sulindac, tamoxifen and celecoxib and banked for future microarray analysis.

### Example IV

### Acquisition and Analysis of Microarray Data

This study was conducted on in-house printed cDNA arrays. However, in order to minimize variability in array quality and increase robustness of the microarray data, a commercial microarray platform was employed for all subsequent studies. After evaluating platforms from several manufacturers, an Affymetrix station was used.

RNA amplification was conducted with the NuGen Ovation™ Biotin System. The Ovation™ Biotin System is powered by Ribo-SPIA technology, a rapid homogeneous and isothermal RNA amplification process that combines fragmentation and direct chemical attachment of biotin to amplified cDNA. Using this technology, microgram quantities of amplified, fragmented, biotin-labeled cDNA were obtained from only 50 ng of starting total RNA. The single-stranded cDNA product generated by NuGen amplification is the antisense of the RNA starting material and is compatible with the probes on the Affymetrix GeneChip platform.

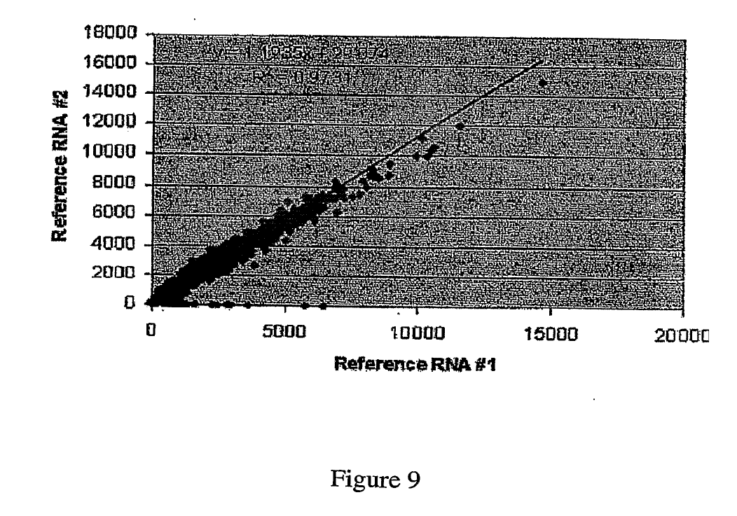

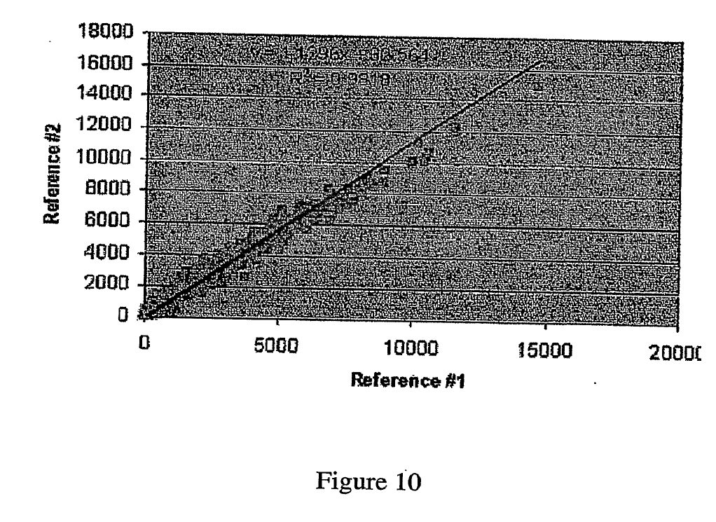

Before processing valuable patient samples, quality control experiments were performed to evaluate experimental reproducibility and establish the correlation among replicate microarray analyses conducted on the same day and on different days. A pilot experiment was conducted in which replicate human reference RNA samples were amplified with NuGen technology and hybridized to Affymetrix arrays. A very good correlation was observed between replicates (0.9731 for all genes (FIG. 9) and 0.9818 for “present” (expressed) genes (FIG. 10)).

Following successful completion of these pilot experiments, RNA samples were extracted from epithelial strains prepared from tumor suppressor gene mutation carriers and controls. A total of 270 RNA samples were processed, from breast, ovarian and renal epithelial strains (n=90, for each target organ). The breast and ovarian epithelial RNAs were obtained from cells cultured from 18 patients (BRCA1 or BRCA2 mutation carriers and wild-type controls; n=6 per group) and treated in vitro with either sulindac, 4-HPR, tamoxifen or vehicle (0.01% DMSO) or left untreated. The kidney epithelial RNAs were obtained from cells cultured from 18 patients (TSC or VHL mutation carriers and wild-type controls; n=6 per group) and treated in vitro with genistein, sulindac, tamoxifen or vehicle (0.01% DMSO) or left untreated.

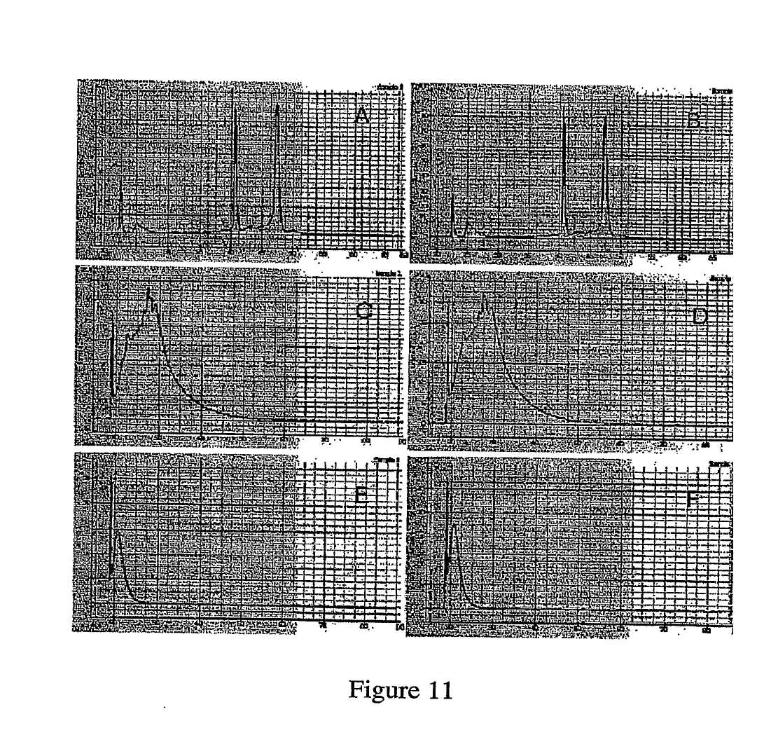

Prior to RNA amplification, the quality of the total RNA for all 270 samples was evaluated by electrophoresis on a nano chip, using the Agilent 2100 Expert Bioanalyzer. Similarly, the bioanalyzer was used to check the quality of both the RNA amplification and the cDNA fragmentation/biotinylation steps for each sample; an additional 540 runs on the Agilent 2100. FIG. 11 shows representative electropherograms of total RNA (panels A and B), amplified cDNA (panels C and D), and fragmented-biotinylated cDNA (panels E and F). Samples that failed these quality control procedures were reamplified. Samples that were successfully biotin-labeled were hybridized to the Affymetrix Human U133 plus 2.0 arrays.

The customized database application accommodates the need for study subject confidentiality, efficient data entry and retrieval, data validation, report generation and subsequent data analyses. Data entry screens were created to enter and update subject demographics, alcohol and tobacco history, germline mutation status, concomitant medication status, biosample, cell strain and RNA data. These electronic data entry screens were created using Oracle Forms V6.0 and incorporate extensive data validation procedures including: variable type checks, range checks, lists of possible values checks, logical consistency checks, and duplicate record checks. The generation, movement, and storage of research materials (e.g., Biosample, RNA, tissue cultures) are tracked by this database system. Investigators have entered information on 621 biological samples. Further, 753 and 2390 data records are stored in the cell strain and RNA extraction data tables, respectively.

All microarray data are being stored within GeneDirector, a commercial microarray data management system from BioDiscovery, Inc. GeneDirector provides a centralized Oracle database representing all stages of the microarray process including, without limitation: array designs (in particular, the Affymetrix U133 plus 2.0 Genechip), samples, experimental protocols, array images, and quantifications. The data can be queried and exported to various analysis tools using the GeneDirector client GUI. GeneDirector supports the MIAME (Minimum Information About a Microarray Experiment) standard of the Microarray Gene Expression Data Society (MGED). Data files produced by Affymetrix GeneChip Operating Software (GCOS) were imported into the database, and associated with RNA sample information (sample IDS, patient age, syndrome, cell type, agent and dose) which was exported from the Oracle database system described above. The GeneDirector interface allows the original Affymetrix output files (e.g., CEL and CHP files, containing probe-level expression data and MAS 5.0 quantified data, respectively) to be exported as necessary, and also allows the flexible export of expression measurements to tab-delimited files for use with other data analysis packages. Data and images related to 270 Affymetrix arrays have been imported into the database, corresponding to all combinations of three tissue types (breast epithelial, ovarian epithelial, renal epithelial), five syndromes (BRCA1, BRCA2, VBL, TSC, wild-type control) and five treatments, with six subjects for every tissue-syndrome pair. To protect these valuable data, both databases are backed up to magnetic tape on a daily basis.

Data obtained using Affymetrix technology were preprocessed using the Robust Multi-chip Average (RMA) method proposed by Irizarry et al. (Irizarry et al. (2003) Nucleic Acids Res. 31:e15; Irizarry et al. (2003) Biostatistics 4:249-264). RMA is a well-published, and cited method, now widely used for preprocessing microarray gene expression probe-level data.

RMA considers raw data (from Affymetrix .CEL files) from multiple arrays (across all experimental conditions) for preprocessing. It includes background adjustment, normalization and summarization. The normalization step is based on the quantile method; i.e., the probe intensities are normalized in each array, based on quantiles, to have the same distribution. The expression indices are summarized as log,-processed intensities. The overall approach accounts for nonlinear relationships as well as variability across arrays. When the number of arrays in the study changes (for example, when arrays are added or removed), this procedure requires that the data be renormalized in their entirety.

The superiority of RMA normalization over Affymetrix's MAS5.0 algorithm as well as other methods has been established by Bolstad et al. (Bolstad et al. (2003) Bioinformatics 19:185-193). Some useful information about RMA can be found at 128.32.135.2/users/bolstad/ComputeRMAFAQ/ComputeRMAFAQ.html. RMA has been implemented in the R Bioconductor Suite (www.bioconductor.org), a set of modules developed exclusively for genomics data analysis; and as RMAExpress, a stand-alone Windows program. The statistical modeling of probe-level data and the incorporation of data from all available arrays into the preprocessing step, as implemented in RMA, has distinct advantages and thus was selected as the method of choice for these analyses.

The primary objective of the study focuses on class comparisons; i.e., to identify genes differentially expressed following various experimental treatments (untreated, DMSO, 4-HPR, sulindac or tamoxifen) and across subgroups of mutation carriers (BRCA1, BRCA2 or wild-type). Within each mutation-treatment combination, the cell strains derived from six patients within each group were treated as technical replicates in the analyses.

Various mutation-treatment combinations are of potential interest. In order to facilitate the interpretation of our findings, we focused on the following primary comparisons for identification of differential expression.

With regard to the comparison of the gene expression profiles of treated and control (DMSO) groups, there are four possible comparisons within each of the three genotypes, giving a total of 12 comparisons. As an example, the gene expression profile of cells from subjects with the BRCA2 genotype that were exposed to DMSO or sulindac can be compared. Because the same cell strains underwent both treatments, a paired test will aid in identifying over- or underexpressed genes in the treated and control groups.

As to the comparison of the gene expression comparison profiles of two genotypes of interest wherein both are exposed to the same treatment, there are five possible comparisons within each of the three genotypes, giving a total of 15 comparisons. For example, the gene expression profiles of untreated cells from BRCA1 (or BRCA2) mutation carriers and control wild-type subjects can be compared to aid in the identification of genes over- or underexpressed under this genotype.

For the comparison of different combinations of treatment (DMSO control vs. each treatment) and genotype, there are four treatment-control combinations for each of three pairs of genotypes, resulting in 12 comparisons. These comparisons also include an interaction effect between treatment and genotype. As an example, the gene expression profiles of cultured cells from BRCA1 mutation carriers and wild-type controls following exposure to DMSO or tamoxifen can be compared. This is a standard two—factor design—genotype and treatment, at two levels each. This allows for the determination of the effect due to genotype or treatment and the interaction between genotype and treatment. Interestingly, in this design, due to pairing of tamoxifen and DMSO within each genotype, a comparison of tamoxifen-DMSO differences (obtained for each genotype) between the genotypes is sufficient and accounts for a treatment and interaction effect.

For class comparisons, variance-stabilizing and normalizing transformations were applied to the data before analysis as appropriate. Class comparison methods applied to the breast, ovarian and renal data sets to date include ANOVA, the LPE method (Jain et al. (2003) Bioinformatics 19:1945-1951), and the nonparametric Wilcoxon test. All comparisons were two-sided. The q-value approach (Storey, J. D. and Tibshirani, R. (2003) Proc. Natl. Acad. Sci., 100:9440-9445) was applied to control the FDR.

Class comparison methods were applied to detect genes differentially expressed under various experimental conditions as outlined in the three examples above. These resulted in a total of 39 distinct gene lists each for breast, ovarian and renal samples. Some comparisons were made using more than one method, resulting in additional gene lists.

In each case, a set of differentially expressed genes was identified based on statistical as well as biological significance. Statistical significance was measured by p-values (from the method used) adjusted for the FDR. Genes showing FDRs of less than the desired cut-off were considered statistically significant. Since the choice of the cut-off itself is flexible, different cut-offs were used for the breast, ovarian and renal data sets (see below).

For the comparison of treated and control groups described above, the paired t-test and the paired Wilcoxon test were applied to the log,-transformed expression intensities in order to detect differentially expressed genes. Similarly, the LPE method was applied to the log₂-transformed expression for the comparison of two genotypes for a given treatment as well as to the difference in log₂ expression between two treatments within a genotype for the comparison of two genotypes across two treatments. Additionally, the two-sample Wilcoxon test was applied to detect differentially expressed genes.

Biological significance was measured by fold change; i.e., the ratio of the mean expression profiles between two conditions. Genes showing more than a 2-fold change in either direction (up- and downregulated) were considered biologically significant. A volcano plot of p-values versus fold change as well as q-values versus fold change (on the log₂ scale) enabled us to visualize the relationship between statistical and biological significance. Differentially expressed genes from each of the above filters were combined, and a list of common genes showing greater statistical and biological significance (lower q-values and up- or downregulated by more than 2-fold) was identified. For exploratory purposes, expression profiles of differentially expressed genes and unsupervised clustering methods were applied to group tissue samples based on genotype and treatments as well as to group genes.

### Example V

### Microarray Expression Profile of Laser-Dissected Tissues from FAP Patients and Controls

In initial experiments, RNA amplification and proof-of-principle experiments were conducted to show that it is possible to generate microarray data from colonic epithelial cells isolated by laser capture microdissection (LCM). LCM of 2250 normal colonic crypts was performed and total RNA isolated. RNA amplification was conducted with two protocols derived from the Eberwine T7 RNA polymerase-based strategy—Stoyanova method (Stoyanova et al. (2004) J. Cell. Physiol., 201:359-365 and the Baugh method (Baugh et al. (2001) Nucleic Acids Res., 29:E29). Each RNA amplification protocol was repeated three times (i.e., in three independent reactions) for a total of six microarray hybridizations. Following amplification, the amplified RNA was compared to itself, in that Cy3-labeled amplified RNA (3 μg) was compared to Cy5-labeled amplified RNA (3 μg). The quality of the obtained images indicated the success in isolating and amplifying RNA from LCM samples. The results confirmed that the correlation coefficients in the three separate hybridizations were very similar to each other for the Baugh method and less similar to each other for the Stoyanova method. This contention was confirmed by an analysis of the standard deviation from the 0 in a log₂ scale examining the Cy3/Cy5 ratio for genes expressed in all channels. Since LCM-derived amplified RNA from normal colonic crypts was being compared to itself, the ratios of expressed genes were expected to center around 1, i.e., 0 in a log₂ scale. Also, the standard deviations for each of the three hybridizations performed with LCM-derived RNA amplified with the Baugh protocol (Baugh et al. (2001) Nucleic Acids Res., 29:E29) were smaller than those for the hybridizations performed with LCM-derived RNA amplified with the Stoyanova method (Stoyanova et al. (2004) J. Cell. Physiol., 201:359-365). These results show that it is possible to generate microarray data from LCM-dissected colonic epithelial cells (see also Upson et al. (2004) J. Cell. Physiol., 201:366-373).

When the NuGen technology for RNA amplification became available, a Ribo-SPIA™-based protocol of linear RNA amplification was implemented for RNA extracted from frozen specimens by LCM. Using LCM specimens of normal colonic mucosa and the Ovations Aminoallyl System, a 9000-fold amplification of LCM-derived RNA was typically achieved. The amplified RNA was hybridized to two-color, 10,000-gene cDNA arrays (10K set from Research Genetics), and the data obtained revealed a high degree of correlation and reproducibility among replicate samples.

Experiments may be conducted on the Affymetrix station by comparing amplification with the Ovation™ Biotin System and the Arcturus RiboAmp method. Amplified probes may be hybridized side-by-side to Human U133 plus 2.0 arrays as well as X3P arrays containing probes enriched for the 3′ region, which might be better for the lower quality RNA which may be obtained by LCM.

### Example VI

### Identification of Potential Molecular Targets for Therapeutic Intervention

By combining the Knudson “two-hit” (Knudson, A. G. (1971) Proc. Natl. Acad. Sci., 68:820-823) and the multistep tumorigenesis theories (Fearon and Vogelstein (1990) Cell 61:759-767; Armitage and Doll (1954) Br. J. Cancer 8:1-12), it may be hypothesized that while biallelic inactivation of the gatekeeper tumor suppressor gene is necessary to initiate tumorigenesis of a given target epithelium, single-hit mutations of this gene might be associated with initial molecular alterations (pre-initiation) present in the morphologically “normal” mucosa. In principle, these early changes would have the highest probability of showing a direct bearing on subsequent tumor induction, and the lowest probability of being marginal by-products of the neoplastic phenotype. Furthermore, they might represent molecular targets for intervention with novel chemopreventive agents. In order to detect these changes, microarray studies of primary epithelial cultures from patients predisposed to cancer, who by definition carry a mutation in one allele of a tumor suppressor gene, and control individuals with intact copies of the tumor suppressor gene were conducted.

Four different sites: colon (predisposing genotypes: APC and MLH1), kidney (predisposing genotypes: VHL and TSC) and breast/ovary (predisposing genotypes: BRCA1/2) were studied. In proof-of-principle experiments, conducted on an in-house, first-generation cDNA microarray platform, it was shown that indeed there might be a significant alteration in gene expression associated with heterozygosity of the tumor suppressor gene for renal epithelial cells.

The distribution of the ratios in TSC and VHL was characterized by averaging the log₂ expression ratios in the replicate experiments and examining the histograms of these distributions. Several of the genes modulated in TSC cells reflect pathways previously implicated in TSC pathogenesis. Transcripts for Rab5A, ribosomal protein S6, rap1A, rap1B and Eukaryotic translation initiation factor 3 were upregulated 3-4-fold in TSC cells. Ribosomal protein S6K was downregulated 2-fold in cells from TSC mutation carriers, while rab4 and rab14 were not detected in the mutant cells. Additional differentially expressed genes included those involved in cell cycle regulation, cytokine signaling, and cell-matrix interactions, genes likely to be involved in the earliest phases of renal cancer progression. Interestingly, several ribosomal protein genes were upregulated in TSC cells. Four of these genes (L6, L21, S6, S25) are human orthologs of yeast ribosomal protein genes downregulated by rapamycin (Cardenas et al. (1999) Genes Dev., 13:3271-3279; Powers. and Walter (1999) Mol. Biol. Cell, 10:987-1000). This suggests that some ribosomal protein genes may be regulated at the transcription level via TSC/mTOR in mammalian cells, much like in yeast.

The transcription factor HIF (hypoxia inducible factor) is overexpressed in kidney cancer associated with either VHL or TSC mutations, suggesting that a normal function of VHL and TSC is to suppress HIF expression. While VHL is known to suppress HIF at the posttranscriptional level by promoting its ubiquitination and degradation (Kim and Kaelin (2003) Curr. Opin. Genet. Dev., 13:55-60), a recent publication indicates that TSC regulates the α subunit of HIF at the transcriptional level (Brugarolas et al. (2003) Cancer Cell 41:47-58). Consistent with these findings, the upregulation of HIF α subunit mRNA was found in heterozygous TSC cells but not in heterozygous VHL renal epithelial cells (FIG. 5).

Furthermore, several of the genes modulated in VHL cells confirmed results obtained by comparing homozygous mutant VHL renal carcinoma lines before and after reconstitution with wild-type VHL cDNA (Zatyka et al. (2002) Cancer Res., 62:3803-3811). Specifically, of the nine genes identified as VHL targets by Zatyka and colleagues, five were upregulated in our heterozygous VHL cell strains.

The microarray experiments for renal epithelial cells were repeated with the Affymetrix station and the analysis to breast and ovarian epithelial cells was expanded. A total of 270 RNA samples were processed, from primary renal, breast and ovarian epithelial strains (n=90 for each target organ). The breast and ovarian epithelial RNAs were obtained from cells cultured from 18 patients (BRCA1 or BRCA2 mutation carriers and wild-type controls; n=6 per group, acting as biological replicates) and treated in vitro with sulindac, 4-HPR, tamoxifen, or vehicle (0.01% DMSO), or left untreated. The renal epithelial RNAs were obtained from 18 patients (VHL or TSC mutation carriers and wild-type controls; n=6 per group, acting as biological replicates) and treated in vitro with sulindac, genistein, tamoxifen, or vehicle (0.01% DMSO), or left untreated.

Using the Affymetrix GeneChip platform, expression data was obtained on 54,675 probe sets for each sample. Affymetrix data were preprocessed and normalized using the RMA method proposed by Irizarry et al. (Irizarry et al. (2003) Nucleic Acids Res., 31:e15; Irizany et al. (2003) Biostatistics 4:249-264). Class comparison analyses were performed in order to identify genes differentially expressed among the different drug treatment groups and across genotypes for each target organ (BRCA1, BRCA2, and wild-type). A 54K gene list was created for each comparison (e.g. BRCA1 vs. wild-type for tamoxifen treatment), and the lists were sorted for ascending FDRs, expressed as q-values, and fold changes.

Several changes in gene expression were identified when genotypes were compared, suggesting that heterozygous mutations in BRCA1 and BRCA2 (for breast and ovary) and in VHL and TSC (for kidney) affect the expression profiles of primary epithelial cells from the respective target organs. For analysis of the comparisons between genotypes within each target organ, a q-value cut-off of 0.20 for breast and 0.10 for both ovary and kidney was used. The different q-values for the various target organs were selected in order to obtain a similar number of genes (ranging from approximately 10 to 100). Then the gene lists were ranked in order to focus on genes exhibiting a fold change of at least 2-fold in each direction. The NetAffx tool available on the Affymetrix web site (www.affymetrix.com) was used to check the correspondence between probe sets and gene names (using an updated library). The results were next compared with those in the literature in order to relate the gene expression differences detected in morphologically normal, heterozygous primary cultures to published studies on tumor cell lines and specimens involving these same genes. The findings for breast, ovarian and renal epithelial cells are summarized below.

Several interesting differences between BRCA1 (i.e., primary breast epithelial cells isolated from women carrying a mutant copy of BRCA1) vs. wild-type, and BRCA2 (i.e., primary breast epithelial cells isolated from women carrying a mutant copy of BRCA2) vs. wild-type were detected. Among these was a 3-5-fold upregulation of mammoglobin, a globin of unknown function, in BRCA1 mutant heterozygous cells. Mammaglobin has been described recently as a novel serum marker of breast cancer, and its expression is specific for breast tissue (Bernstein et al. (2005) Clin. Cancer Res., 11:6528-6535). Approximately 80% of all breast cancers, regardless of breast cancer type or stage, overexpress the mammaglobin protein complex known as secretoglobin or uteroglobin family when compared to normal breast tissue (Bernstein et al. (2005) Clin. Cancer Res., 11:6528-6535). Interestingly, the same cultures exhibited a 10-17-fold (i.e., the lowest of the six samples was 10-fold and the highest 17-fold) upregulation of the gene encoding lipophilin B, a protein that can heterodimerize with mammaglobin.

Many genes involved in cell-to-cell interactions and cell-to-matrix adhesion were also downregulated, including tensin 4 and mucin16 (both in BRCA1 and BRCA2 vs. wild-type) and keratin 14 (in BRCA2 vs. wild-type). Lack of tensin 4 expression has been reported in prostate and breast cancers, suggesting that the downregulation of tensin expression is a functional marker of cell transformation (Rodriguez et al. (2005) Oncogene 24:3274-3284). Also, loss of keratins, which are necessary for proper structure and function of desmosomes, can cause an increase in cell flexibility and deformability; these may be important changes in the process that enables a tumor cell to detach from its epithelial layer, become invasive, and metastasize. Finally, mucin 1 (or CA 15-3) is overexpressed in breast cancers. As a consequence of the overrepresentation of one glycoprotein, cell surface protein distribution may change and compensatory mechanisms may affect other membrane proteins; for example, downregulation of mucin 16.

The comparisons for ovary involved primary ovarian surface epithelial (HOSE) cells isolated from the ovaries of women carrying a mutant copy of BRCA1 vs. wild-type, and primary ovarian surface epithelial cells isolated from the ovaries of women carrying a mutant copy of BRCA2 vs. wild-type. The data suggest that some abnormalities in cell cycle control may occur in BRCA 1 cells. For example, downregulation of the mRNAs encoding the cyclin B1/cdc2 complex, a key regulator controlling the G₂M checkpoint, was observed. Multiple genes implicated in the mitotic spindle checkpoint, such as nucleolar and spindle-associated protein 1 (NUSAP-1) and centromere protein A (CENP-A), were downregulated. NUSAP-1 has a crucial role in spindle microtubule organization, while CENP-A is essential for centromere structure, function and kinetochore assembly. Since BRCA1 and BRCA2, in addition to their role in DNA repair, are also involved in checkpoint pathways, we can speculate that inappropriate expression of these proteins could induce abnormal kinetochore function and chromosome missegregation, a potential cause of aneuploidy and critical contributor to oncogenesis.

Genes upregulated in BRCA1 heterozygous HOSE cells included CD24 (small cell lung carcinoma cluster 24 antigen), a heavily glycosylated glycosylphosphatidylinositol-linked cell surface protein and ligand of P-selectin. CD24 has been suggested previously as a candidate molecular marker of epithelial ovarian cancer (Choi et al. (2005) Gynecol. Oncol., 97:379-386). Serum amyloid A2 (SAA2), the acute phase protein and component of innate immune system, was upregulated (4-5-fold) in heterozygous BRCA1 HOSE cells. SAA2 is a marker of inflammation that is very similar in sequence and highly related to SAA1, known as serum amyloid precursor, which has been identified as a biomarker for epithelial ovarian cancer, based on plasma mass spectrometry (Khan et al. (2004) Cancer 101:379-384; Moshkovskii et al. (2005) Proteomics 5:3790-3797). In addition to ovarian cancer, SAA1 has also been proposed as a marker for lung and renal cancer (Khan et al. (2004) Cancer 101:379-384; Moshkovskii et al. (2005) Proteomics 5:3790-3797). Due to the lack of sufficiently specific markers for most cancer types, data on the disease behavior of plasma species, including apolipoproteins, may be very useful clinically.

Ponsin was found to be upregulated 7-14-fold in BRCA1 mutant cells vs. wild-type. Ponsin (also known as SH3D5) belongs to the adaptor protein family that also includes vinexin and Arg-binding protein 2. SH3D5 and other members of the adaptor protein family contain three src homology 3 (SH3) domains without enzymatic activity, suggesting that they function as adaptor molecules or scaffolding molecules in signal transduction pathways. These adaptors have a role in the regulation of cell adhesion, actin cytoskeleton organization and growth factor signal transduction. Ponsin, through one SH3 domain, binds to Sos, a guanine nucleotide exchange factor for Ras and Rac. Other SH3 domain-containing proteins can interact with the oncoproteins Abl and Arg. The mechanistic details of how adaptor proteins coordinate regulation of cytoskeleton organization and signal transduction remains to be determined.

A dramatic upregulation (8-30-fold) of the gene encoding chitinase 3-like 1 (CHI3L1 or YKL-40) was detected in both BRCA1 and BRCA2 heterozygous mutant epithelial cells. This mammalian chitinase-like protein is secreted by chondrocytes and tumor cells and induces proliferative effects on stromal fibroblasts and chemotactic effects on endothelial cells. Chitinase 3-like 1 protein can also promote angiogenesis. High levels have been found in the serum and biopsies of glioblastoma patients (Junker et al. (2005) Cancer Sci., 96:183-190).

Similar to BRCA1, several genes were found to be differentially expressed in BRCA2 mutant heterozygous HOSE cells vs. wild-type. For example, matrix metalloproteinase 3 (MMP3) was found to be upregulated 9-12-fold. This finding is consistent with the same tendency of gain of function of metalloproteinase in cancers, especially MMP1,2 and 3, which have been validated for ovarian cancer. Finally, the data suggest upregulation of COX-1 (cyclooxygenase-1) in BRCA2 mutant heterozygous HOSE cells. Whereas overwhelming evidence suggests a role for COX-2 in a variety of cancers, the contribution of COX-1 remains much less explored. Furthermore, the expression status of COX isoforms in ovarian cancers remains confusing. There is evidence of upregulation of COX-1 but not COX-2 in ovarian cancer, and the findings in patients with genetic predisposition to ovarian cancer are consistent with these studies.

In comparison to the gene lists for breast and ovarian mutation carriers, the number of genes differentially expressed in renal epithelial cells is much larger (approximately 4 times more genes are within the indicated cutoff of q-value in kidney vs. breast and ovary comparisons). Comparison of heterozygous TSC vs. wild-type primary cells revealed that many endothelial markers and cell adhesion molecules were downregulated, while oncogenes were upregulated. Dramatic loss of expression of aquaporin 1 (AQ-1), a water channel protein with preferential localization in the renal proximal convoluted tubules and the descending thin limb of the loop of Henle, was observed in heterozygous TSC primary renal epithelial cells. AQ-1 is considered a differentiation marker of proximal renal tubular cells. Downregulation of AQ-1 has been associated with loss of the differentiated phenotype and poor prognosis in renal cell carcinoma (RCC) (Takenawa et al. (1998) Intl. J. Cancer 79:1-7; Ho et al. (2005) BJU Int. 95:1104-1108). These data suggest that some aspects of oncogenic transformation are present in TSC cells. Downregulation of endothelial markers such as vascular cell adhesion molecule 1 (VCAM1), mucin 18 (muc 18 or MCAM), and thrombomodulin (THBD) was also noted. In particular, THBD is known to be underexpressed in abnormal growth conditions, from moderate to severe dysplasia to cancer (Hanly et al. (2005) Eur. J. Surg. Oncol., 31:217-220).

Angiogenesis is absolutely required for tumor growth. It has been reported that downregulation of thrombospondin (THBS), a potent inhibitor of tumor growth and angiogenesis, is a prerequisite for acquisition of a proangiogenic phenotype (Jo et al. (2005) Cancer Biol. Ther. 4:1361-6). Interestingly, THBS was downregulated (5-10-fold) in TSC cells vs. wild-type cells.

As mentioned earlier, the data reveal upregulation of several oncogenes in TSC cells such as erbB4 (v-erb-a avian erythroblastic leukemia viral oncogene homolog-like 4) and Vav-3. Although the transforming potential of erbB4 remains controversial, there are reports indicating higher levels of erbB4 in many neoplasias (Maatta et al. (2006) Mol. Biol. Cell, 17:57-79). In contrast, it is accepted that the Vav-3 oncogene modulates Ros receptor protein tyrosine kinase signaling, regulates GTPase activity and cell morphology, and induces cell transformation (Zeng et al. (2000) Mol. Cell. Biol., 20:9212-9224).

Finally, the data suggest upregulation of some growth factor receptors, such as fibroblast growth factor receptor 2 (FGFR2), in both TSC and VHL cells vs. wild-type cells. FGFR2 can mediate signaling events leading to regulation of cell proliferation, differentiation, migration, survival and shape.

Interestingly, the Wilms tumor 1 gene (WT1) was downregulated in TSC and VHL samples, 5- and 2-fold, respectively. Wilms tumors are the most common malignant neoplasms of the urinary tract in children. WTI is a tumor suppressor gene with a role in negative regulation of cell cycle. WTI induces apoptosis through transcriptional regulation of a member of the proapoptotic family Bcl-2. WTI controls the mesenchymal-epithelial transition during renal development (Morrison et al. (2005) Cancer Res. 65:8174-8182), and its differential expression has been reported in many other cancers including ovarian, breast and colorectal carcinomas (Kaneuchi, et al. (2005) Cancer 104:1924-1930).

Pappalysin 1 was downregulated in both TSC and VHL cells vs. wild-type cells, 4- and 3-fold, respectively. Pappalysin 1 is an insulin-like growth factor binding protein protease that cleaves IGFBP-4, thus increasing IGF availability and promoting cell growth. It appears to function as a posttranslational modulator of IGF bioavailability in response to injury (Resch et al. (2005) Endocrinology 147:885-890).

In TSC samples, tetraspanin 8, also known as tumor-associated antigen CO-029, was upregulated. Tetraspanin proteins mediate signal transduction events that play a role in the regulation of development, activation, growth and motility. In particular, tetraspanin 8 is a cell surface glycoprotein that forms a complex with integrins. In many carcinomas, its expression correlates with increased tumor cell motility and metastasis (Gesierich et al. (2005) Clin. Cancer Res., 11:2840-2852).

In VHL cells, downregulation of pinin (PNN), a gene that encodes a desmosomal-related protein involved in cell adhesion, was observed. It is well known that many cell adhesion proteins act as tumor suppressors, and PNN downregulation has been reported in various tumors. PNN and other cell adhesion proteins, such as plakoglobin and β-catenin, play a central role in coordinating cell adhesive and nuclear events that are essential in development, tissue remodeling and tumor progression. Restoration of PNN expression in transformed cells reverses the transformed phenotype to one that is more epithelial-like (Shi et al. (2000) Oncogene 19:289-297), suggesting that PNN may have an involvement in epithelial-mesenchymal transition.

It may be hypothesized that some alterations in protein biosynthesis take place in VHL cells, because it was noticed that differential expression of the ribosomal protein genes when compared to wild-type cells. For example, RPS27L (ribosomal protein S27-like) is upregulated, while RPSA4Y1 (ribosomal protein S4, Y-linked 1) is down-regulated.

S100P calcium-binding protein, a 95-amino acid member of the S100 family of proteins, was upregulated in VHL cells. It has been reported that S100P levels correlate with cell proliferation, survival, migration, and invasion in mouse models (Arumugam et al. (2005) Clin. Cancer Res., 11:5356-5364). In addition, S100P plays a major role in-the aggressiveness of pancreatic cancer. S100P was found highly expressed in several tumorigenic cell lines derived from colorectal and breast carcinomas (Gibadulinova et al. (2005) Oncol. Rep., 14:575-582), suggesting that its expression is not restricted to a particular tumor type.

Finally, upregulation of cyclin B1 in VHL cells was observed. Cyclin B1 is essential for the control of the cell cycle at the G2/M transition. It accumulates steadily during G2 and is abruptly destroyed at mitosis. Cyclin B1 accumulation may disrupt normal cell cycle control.

After completing the microarray analyses for the renal epithelial cells on the Affymetrix GeneChip platform, the newly generated Affymetrix data were compared with the results obtained previously for TSC and VHL renal epithelial cells on the in-house cDNA microarray platform. In particular, upregulation of the HIF1α mRNA had been observed in cells with mutant TSC but not in cells with mutant VHL. Although less pronounced, this differential upregulation was confirmed in the Affymetrix data set. In addition, upregulation of the mRNAs is reported for collagen type VIIIα1, interleukin 6, low-density lipoprotein-related protein 1, VEGF and CD59 in heterozygous VHL cells. Upregulation of all of these transcripts was confirmed, with the exception of low-density lipoprotein-related protein 1 mRNA, whose levels remained unchanged.

Increased expression of transcripts for several ribosomal proteins was detected in renal epithelial cells heterozygous for mutant TSC. Although less pronounced, the same upregulation was noted in cells heterozygous for mutant VHL. In the Affymetrix data set, the genes encoding for ribosomal proteins S15A, L10A, L39, S6, S12, S27A (only TSC), L36A, L6, S8, S4 X-linked, S25 (only VHL), S23 (only TSC), L21, L5 and L11 were transcriptionally upregulated slightly. A small fraction of ribosomal protein genes were identified as being downregulated when using the FCCC cDNA microarray platform. In the Affymetrix data set, a slight downregulation of the genes encoding ribosomal proteins S4 Y-linked, S28 (TSC only), L28, S5, L37A, L10, L18, L35 (TSC only) was also observed. Thus, these observations confirm that alterations in pathways of ribosome biosynthesis might be present in both cells with mutant TSC and mutant VHL.

In conclusion, these analyses of primary cultures from different target organs indicate that heterozygosity for tumor suppressor gene mutations is associated with detectable changes in their gene expression profile. In many cases, changes detected in morphologically normal, heterozygous BRCA1/2 breast and ovarian epithelial cells, and in morphologically normal, heterozygous VHL/TSC renal epithelial cells are consistent with the known biology of these genes in homozygous mutant cancer cells from the respective target organs. These alterations in the gene expression profile may represent early molecular changes in the process of tumorigenesis.

### Example VIII

### Summary Tables

TABLE 9
Demographic and Clinical Information of the FAP Cases.

| | | | Location | | | | |
|---|---|---|---|---|---|---|---|
| | | | of APC | | | | |
| SID | Age | Gender | Mutation | Phenotype | Rel | Ethnicity | Chemoprevention |
| 316 | 23 | F | Codon | | A | Asian | No |
| | | | 1072 | | | | |
| 317 | 23 | F | None | Attenuated | | Caucasian | No |
| 330 | 22 | M | Stop at | | | Caucasian | No |
| | | | Codon | | | | |
| | | | 1275, | | | | |
| | | | S1275X | | | | |
| 333 | 31 | M | Codon | | A | Asian | Sulindac |
| | | | 1072 | | | | |
| 344 | 42 | M | Unknown | | | Unknown | No |
| 345 | 21 | M | Codon | | | Caucasian | Sulindac |
| | | | 245 | | | (Greek) | |
| | | | (Genetically | | | | |
| | | | attenuated) | | | | |
| 346* | 24 | F | Codon | | B | Caucasian | Celecoxib |
| | | | 564 | | | | |
| 347 | 19 | M | None | >50 | | Caucasian | No |
| | | | | polyps | | | |
| 380 | 18 | F | Codon | | | Caucasian | No |
| | | | 1935 | | | | |
| 384 | 22 | M | Codon | | B | Caucasian | No |
| | | | 564 | | | | |
| 426 | 19 | F | Codon | | | Caucasian | No |
| | | | 302 | | | | |
| 484 | 53 | M | 3 bp | Low | | Caucasian | Valdecoxib |
| | | | before | polyp | | | |
| | | | Exon 4 | burden | | | |
| | | | (nonconsensus | ~75 | | | |
| | | | IVS) | polyps | | | |
| | | | (Genetically | | | | |
| | | | attenuated) | | | | |
| 490 | 19 | M | 3443 | | C | Caucasian | No |
| | | | delCT | | | | |
| | | | (Codon | | | | |
| | | | 1148) | | | | |
| 491 | 17 | M | Q233X, | Severe | | Hispanic | No |
| | | | Codon | | | | |
| | | | 223 | | | | |
| | | | (Genetically | | | | |
| | | | attenuated) | | | | |
| 492 | 49 | F | Codon | | A | Asian | No |
| | | | 1072 | | | | |
| 510 | 37 | F | 453 delA | | | Caucasian | No |
| | | | (AA 169) | | | | |
| 514 | 17 | F | 3443 | | C | Caucasian | No |
| | | | delCT | | | | |
| | | | (Codon | | | | |
| | | | 1148) | | | | |
| 516 | 39 | F | 509 del4, | Attenuated | | Caucasian | No |
| | | | Codon | | | | |
| | | | 173 | | | | |
| | | | (Genetically | | | | |
| | | | attenuated) | | | | |
| 548 | 45 | F | 2802 del4 | | | Caucasian | No |
| | | | (AA 953) | | | | |
| 549 | 34 | F | R216X | | | Caucasian | No |
| | | | (AA 216) | | | | |
| 576 | 16 | F | 3443 | | C | Caucasian | No |
| | | | delCT | | | | |
| | | | (Codon | | | | |
| | | | 1148) | | | | |
| 597 | 48 | F | 426 | | | Caucasian | No |
| | | | delAT | | | | |
| | | | (AA 146) | | | | |
| | | | (Genetically | | | | |
| | | | attenuated) | | | | |
| 598 | 24 | F | 3183 del5 | Cancer | | Caucasian | No |
| | | | (AA | | | | |
| | | | 1062) | | | | |
| 601 | 48 | M | Exon 4, | | | Caucasian | No |
| | | | IVS4 + G > A | | | | |
| | | | (Genetically | | | | |
| | | | attenuated) | | | | |
| 602 | 42 | M | 3714 delT | | | Caucasian | No |
| | | | (AA | | | | |
| | | | 1264) | | | | |
| 608 | 24 | M | 3927 del5 | | | Asian | No |
| | | | (AA | | | | |
| | | | 1312) | | | | |
| 609 | 23 | F | 3183 del5 | | | Hispanic | No |
| | | | (AA | | | | |
| | | | 1062) | | | | |
| 610 | 17 | F | No | | | Hispanic | No |
| | | | mutation | | | | |
| | | | by | | | | |
| | | | sequencing | | | | |
| 618 | 35 | F | 3443 | | C | Caucasian | No |
| | | | delCT | | | | |
| | | | (AA | | | | |
| | | | 1148) | | | | |
| 622 | 26 | M | 3183 del5 | | | Caucasian | No |
| | | | (AA | | | | |
| | | | 1062) | | | | |

*no growth of “epithelial” cells in 1% FBS.

TABLE 10
Summary of cell strains established to date from
MLH1 mutation carriers.

| | | Colon | | |
|---|---|---|---|---|
| | | Epithelial | | |
| | Colon “Epithelial”* | 0.04 mM | Colon Fibroblasts | Blood |
| SID | 1% FBS | Calcium | 15% FBS | Processed |
| 332 | Left (Right in | No growth | Left, Right | ✓ |
| | culture) | | | |
| 335 | Left, Right | No growth | Left, Right | ✓ |
| 338 | Left | No growth | Left, Right | |
| 350 | Left, Transverse | No growth | Left, Transverse | ✓ |
| 398 | Left | No growth | Left, Right | ✓ |
| 399 | Left, Right | No growth | Left, Right | ✓ |
| 480 | Left | No growth | Currently in culture | ✓ |
| 481 | Left, Right | No growth | Left, Right | ✓ |
| 482 | Right | No growth | Right | |
| 515 | Proximal, Distal | No growth | Proximal, Distal | ✓ |
| 535 | Left, Right | No growth | Left, Right | ✓ |
| 546 | Left, Right | No growth | Left, Right | ✓ |
| 550 | Right | No growth | Left | ✓ |
| 619 | Left, Right | No growth | Left, Right | ✓ |
| 623 | Currently in culture | Currently | Currently in culture | ✓ |
| | | in culture | | |
| 624 | Currently in culture | Currently | Currently in culture | ✓ |
| | | in culture | | |

*uncertain if all cells are epithelial.

TABLE 11
Summary of cell strains established to date from FAP patients.

| | | Colon | | | |
|---|---|---|---|---|---|
| | Colon | Epithelial** | Colon | | |
| | “Epithelial”* | 0.04 mM | Fibroblasts | Skin | Blood |
| SID | 1% FBS | Calcium | 15% FBS | 15% FBS | Processed |
| 316 | Left, Right | No growth | Left, Right | No | |
| 317 | Proximal | No growth | Proximal, | ✓ | |
| | | | Mid, Distal | | |
| 330 | Left, Right | No growth | Left | ✓ | |
| 333 | Left | Left | Left, Right | No | |
| 344 | Proximal, | No growth | Proximal, | No | |
| | Distal | | Distal | | |
| 345 | Left, Right | No growth | Left, Right | No | |
| 346 | No growth | No growth | Right | No | ✓ |
| 347 | Left, Right | Left | Left | ✓ | ✓ |
| 380 | Left, Right | No growth | Left, Right | No | ✓ |
| 384 | Right | No growth | Left | No | ✓ |
| 426 | Left, Right | Left | Left, Right | No | ✓ |
| 484 | Left, Right | No growth | Left, Right | No | ✓ |
| 490 | Left, Right | No growth | Left, Right | ✓ | ✓ |
| 491 | Left, Right | No growth | Left, Right | ✓ | ✓ |
| 492 | Left, Right | No growth | Left, Right | ✓ | ✓ |
| 510 | Left, Right, | No growth | Left, Right, | ✓ | ✓ |
| | Caecum | | Caecum | | |
| 514 | Left, Right | No growth | Left, Right | ✓ | ✓ |
| 516 | Left | No growth | Left, Right | ✓ | ✓ |
| 548 | Left, Right | Left | Left, Right | ✓ | ✓ |
| 549 | Left, Right | No growth | Left, Right | ✓ | ✓ |
| 576 | Left, Right | No growth | Left, Right | ✓ | ✓ |
| 597 | Left, Right | No growth | Left | ✓ | ✓ |
| 598 | None | No growth | None | Not | ✓ |
| | | | | processed | |
| 601 | Right | No growth | Left, Right | ✓ | ✓ |
| 602 | Left, Right | No growth | Left, Right | ✓ | ✓ |
| 608 | Left, Right | Currently in | Left, Right | ✓ | |
| | | culture | | | |
| 609 | Left, Right | Currently in | Left, Right | ✓ | ✓ |
| | | culture | | | |
| 610 | Left, Right | Currently in | Left, Right | ✓ | ✓ |
| | | culture | | | |
| 618 | Left, Right | Currently in | Left, Right | ✓ | ✓ |
| | | culture | | | |
| 622 | Left, Right | Currently in | Left, Right | ✓ | ✓ |
| | | culture | | | |

*uncertain if all cells are epithelial;
**these cells are fully epithelial, as determined by IHC with eight markers.

TABLE 12
Summary of cell strains established to date from healthy controls.

| | Colon Epithelial* | Colon Epithelial | Colon Fibrobla |
|---|---|---|---|
| SID | 1% FBS | 0.04 mM Calcium | 15% FBS |
| 336 | Not tested | No growth | ✓ |
| 340 | ✓ | ✓ (?) | ✓ |
| 341 | No growth | No growth | Right |
| 461 | Left | No growth | Left, Right |
| 471 | Left, Right | No growth | Left, Right |
| 472 | Left, Right | No growth | Left, Right |
| 483 | Left, Right | No growth | Left, Right |
| 507 | Left, Right | No growth | Left, Right |
| 508 | Left, Right | No growth | Left, Right |
| 509 | Left | No growth | Left, Right |
| 511 | Left | No growth | Left, Right |
| 513 | Right | No growth | Right |

*uncertain if all cells are epithelial.

TABLE 13
Demographic and clinical information of the FAP cases.

| | | | Location of | | | | Chemo- |
|---|---|---|---|---|---|---|---|
| SID | Age | Gender | APC Mutation | Phenotype | Rel. | Ethnicity | prevention |
| 316 | 23 | F | Codon 1072 | | A | Asian | No |
| 330 | 22 | M | Stop at Codon | | | Caucasian | No |
| | | | 1275, S1275X | | | | |
| 333 | 31 | M | Codon 1072 | | A | Asian | Sulindac |
| 344 | 42 | M | Unknown | | | Unknown | No |
| 345 | 21 | M | Codon 245 | | | Caucasian | Sulindac |
| | | | (Genetically | | | (Greek) | |
| | | | attenuated) | | | | |
| 347 | 19 | M | None | >50 polyps | | Caucasian | No |
| 426 | 19 | F | Codon 302 | | | Caucasian | No |
| 484 | 53 | M | 3 bp before | Low polyp | | Caucasian | Valdecoxib |
| | | | Exon 4 | burden, | | | |
| | | | (nonconsensus | ~75 polyps | | | |
| | | | IVS) | | | | |
| | | | (Genetically | | | | |
| | | | attenuated) | | | | |
| 490 | 19 | M | 3443 delCT | | C | Caucasian | No |
| | | | (Codon 1148) | | | | |
| 491 | 17 | M | Q233X, Codon | Severe | | Hispanic | No |
| | | | 223 | | | | |
| | | | (Genetically | | | | |
| | | | attenuated) | | | | |
| 492 | 49 | F | Codon 1072 | | A | Asian | No |
| 510 | 37 | F | 453 delA (AA | | | Caucasian | No |
| | | | 169) | | | | |
| 514 | 17 | F | 3443 delCT | | C | Caucasian | No |
| | | | (Codon 1148) | | | | |
| 516 | 39 | F | 509 del4, | Attenuated | | Caucasian | No |
| | | | Codon 173 | | | | |
| | | | (Genetically | | | | |
| | | | attenuated) | | | | |
| 547 | 49 | F | 503 delG (AA | | | Caucasian | |
| | | | 169) | | | | |
| 548 | 45 | F | 2802 del4 (AA | | | Caucasian | No |
| | | | 953) | | | | |
| 549 | 34 | F | R216X (AA | | | Caucasian | No |
| | | | 216) | | | | |
| 576 | 16 | F | 3443 delCT | | C | Caucasian | No |
| | | | (Codon 1148) | | | | |
| 597 | 48 | F | 426 delAT (AA | | | Caucasian | No |
| | | | 146) | | | | |
| | | | (Genetically | | | | |
| | | | attenuated) | | | | |
| 598 | 24 | F | 3183 del5 (AA | Cancer | | Caucasian | No |
| | | | 1062) | | | | |
| 601 | 48 | M | Exon 4, | | | Caucasian | No |
| | | | IVS4 + G > A | | | | |
| | | | (Genetically | | | | |
| | | | attenuated) | | | | |
| 602 | 42 | M | 3714 delT (AA | | | Caucasian | No |
| | | | 1264) | | | | |
| 608 | 24 | M | 3927 del5 (AA | | | Asian | No |
| | | | 1312) | | | | |
| 609 | 23 | F | 3183 del5 (AA | | | Hispanic | No |
| | | | 1062) | | | | |
| 610 | 17 | F | No mutation by | | | Hispanic | No |
| | | | sequencing | | | | |
| 618 | 35 | F | 3443 delCT | | C | Caucasian | No |
| | | | (AA 1148) | | | | |
| 622 | 26 | M | 3183 del5 (AA | | | Caucasian | No |
| | | | 1062) | | | | |

TABLE 14
FAP cases.

| | Number | | | | | | | |
|---|---|---|---|---|---|---|---|---|
| | of | | Gender of | | Distribution of colon samples | | | |
| | patients | | the | | from patients with | | | |
| | from | | patients | | confirmed mutations (classified | | | |
| | whom | Patients | with | | by site of collection) | | | |
| | samples | with | confirmed | | | | Proximal | Location |
| | were | confirmed | mutations | | | | and | was not |
| Diagnosis | collected | mutations | M | F | Proximal | Distal | Distal | recorded |
| FAP | 13 | 8 | 4* | 4 | 0 | 2 | 1 | 5 |

*one FAP patient was treated with celecoxib prior to sample collection.

While the invention has been described in detail and with reference to specific examples thereof, it will be apparent to one skilled in the art that various changes and modifications can be made therein without departing from the spirit and scope thereof.

What is claimed is:

1. A microarray of differentially expressed nucleic acid molecules identified in heterozygous carriers of a mutant BRCA1 associated with the onset of breast cancer, said microarray comprising at least one of mammogloblin, lipophilin B, tensin 4, mucin 16.

2. A microarray of differentially expressed nucleic acid molecules identified in heterozygous carriers of a mutant BRCA2 associated with the onset of breast cancer, said microarray comprising at least one of tensin 4, mucin 16, and keratin 14.

3. A microarray of differentially expressed nucleic acid molecules identified in heterozygous carriers of a mutant BRCA1 associated with the onset of ovarian cancer, said microarray comprising at least one of cyclin B1, cdc2, NUSAP-1, CENP-A, CD24, SAA2, ponsin, and CHI3L1.

4. A microarray of differentially expressed nucleic acid molecules identified in heterozygous carriers of a mutant BRCA2 associated with the onset of ovarian cancer, said microarray comprising at least one of CHI3L1, MMP3, and COX-1.

5. A microarray of differentially expressed nucleic acid molecules identified in heterozygous carriers of a mutant TSC associated with the onset of renal cancer, said microarray comprising at least one of AQ-1, THBS, erbB4, Vav-3, FGFR2, WT1, and pappalysin 1.

6. A microarray of differentially expressed nucleic acid molecules identified in heterozygous carriers of a mutant VHL associated with the onset of renal cancer, said microarray comprising at least one of FGFR2, WT1, pappalysin 1, tetraspanin 8, PNN, RPS27L, RPSA4Y, S100P, and cyclin B1.

7. The microarray of claim 1, wherein said microarray comprises nucleic acid molecules attached to a solid support.

8. The microarray of claim 2, wherein said microarray comprises nucleic acid molecules attached to a solid support.

9. The microarray of claim 3, wherein said microarray comprises nucleic acid molecules attached to a solid support.

10. The microarray of claim 4, wherein said microarray comprises nucleic acid molecules attached to a solid support.

11. The microarray of claim 5, wherein said microarray comprises nucleic acid molecules attached to a solid support.

12. The microarray of claim 6, wherein said microarray comprises nucleic acid molecules attached to a solid support.

13. A method for identifying a genetic signature for heterozygous carriers of a mutant gene associated with cancer, comprising the steps of:
a) obtaining a biological sample from a heterozygous carrier of a mutant gene associated with cancer;
b) generating detectably labeled probes from the nucleic acid molecules of said biological sample;
c) contacting a microarray with said detectably labeled probes under conditions that facilitate hybridization between complementary nucleic acids, if any are present;
d) analyzing said microarrays for hybrids, if any are present; and
e) comparing the hybridization profile from said heterozygous carrier with the hybridization profile from a biological sample from a normal individual, wherein said genetic signature of heterozygous carriers of a mutant gene associated with cancer comprises those nucleic acid sequences which are differentially expressed between said heterozygous carriers and said normal individuals.

14. The method of claim 13, wherein said gene associated with cancer is a tumor suppressor gene.

15. The method of claim 13, wherein said gene associated with cancer is an oncogene.

16. The method of claim 13, wherein said gene associated with cancer is a DNA repair gene.

17. The method of claim 13, wherein said tumor suppressor gene is selected from the group consisting of TSC1, TSC2, and VHL.

18. A method for the early detection of a cancer in a patient, said method comprising assessing the patient for the presence or absence of the genetic signature of claim 13.

19. A microarray of differentially expressed nucleic acid molecules identified in heterozygous carriers of mutant tumor suppressor genes, said microarray comprising at least one of HSPA8, RAB2, NK4, and NDRG2, wherein said tumor suppressor gene is selected from the group consisting of TSC 1, TSC2, and VHL, and wherein said mutant tumor suppressor gene is associated with the onset of renal cancer.

20. A microarray of differentially expressed nucleic acid molecules identified in heterozygous carriers of mutant tumor suppressor genes, said microarray comprising at least one of the genes provided in FIG. 4, wherein said tumor suppressor gene is selected from the group consisting of TSC1, TSC2, and VHL, and wherein said mutant tumor suppressor gene is associated with the onset of renal cancer.

21. A microarray of differentially expressed nucleic acid molecules identified in heterozygous carriers of mutant tumor suppressor genes, said microarray comprising at least one of the genes provided in FIG. 6, wherein said tumor suppressor gene is selected from the group consisting of TSC1, TSC2, and VHL, and wherein said mutant tumor suppressor gene is associated with the onset of renal cancer.

22. The microarray of claim 19, wherein said microarray comprises nucleic acid molecules attached to a solid support.

23. The microarray of claim 20, wherein said microarray comprises nucleic acid molecules attached to a solid support.

24. The microarray of claim 21, wherein said microarray comprises nucleic acid molecules attached to a solid support.


SEQUENCE LISTING (22 sequences)

SEQ ID NO: 1 - DNA, 66 bp, Artificial Sequence
  Synthetic Sequence
aaacgacggccagtgaattgtaatacgactcactataggcgctttttttttttttttttttttttt

SEQ ID NO: 2 - DNA, 16 bp, Artificial Sequence
  Synthetic Sequence
ccctggcacccagcac

SEQ ID NO: 3 - DNA, 19 bp, Artificial Sequence
  Synthetic Sequence
gccgatccacacggagtac

SEQ ID NO: 4 - DNA, 27 bp, Artificial Sequence
  Synthetic Sequence
atcaagatcattgctcctcctgagcgc

SEQ ID NO: 5 - DNA, 19 bp, Artificial Sequence
  Synthetic Sequence
gaggctgagatcgccacct

SEQ ID NO: 6 - DNA, 20 bp, Artificial Sequence
  Synthetic Sequence
tgtccaaggcatcaccaaga

SEQ ID NO: 7 - DNA, 20 bp, Artificial Sequence
  Synthetic Sequence
ccgccgcctgctggaagatg

SEQ ID NO: 8 - DNA, 20 bp, Artificial Sequence
  Synthetic Sequence
tggcttccttcgttattgga

SEQ ID NO: 9 - DNA, 20 bp, Artificial Sequence
  Synthetic Sequence
caactgcaggtcccttggac

SEQ ID NO: 10 - DNA, 23 bp, Artificial Sequence
  Synthetic Sequence
ccaggcctacaccccagcaacca

SEQ ID NO: 11 - DNA, 27 bp, Artificial Sequence
  Synthetic Sequence
agataaaacttcagatatgggatacgg

SEQ ID NO: 12 - DNA, 22 bp, Artificial Sequence
  Synthetic Sequence
gctgcacctctgtaatacgacc

SEQ ID NO: 13 - DNA, 27 bp, Artificial Sequence
  Synthetic Sequence
agggcaagaatcctttcgttccatcac

SEQ ID NO: 14 - DNA, 17 bp, Artificial Sequence
  Synthetic Sequence
cccaatgccaagggttg

SEQ ID NO: 15 - DNA, 20 bp, Artificial Sequence
  Synthetic Sequence
tccggaatggaagaggtgag

SEQ ID NO: 16 - DNA, 25 bp, Artificial Sequence
  Synthetic Sequence
atggattgggcagcccacaagctaa

SEQ ID NO: 17 - DNA, 20 bp, Artificial Sequence
  Synthetic Sequence
ttaccatgccccagattcag

SEQ ID NO: 18 - DNA, 24 bp, Artificial Sequence
  Synthetic Sequence
attcactgggactattaggctcag

SEQ ID NO: 19 - DNA, 29 bp, Artificial Sequence
  Synthetic Sequence
agacacctagtccttccgatggaagcact

SEQ ID NO: 20 - DNA, 17 bp, Artificial Sequence
  Synthetic Sequence
ttgggtgcattggagcc

SEQ ID NO: 21 - DNA, 16 bp, Artificial Sequence
  Synthetic Sequence
gggtgcagcctgggac

SEQ ID NO: 22 - DNA, 24 bp, Artificial Sequence
  Synthetic Sequence
tgccttgctgctctacctccacca